(19) United States
(12) Patent Application Publication
(10) Pub. No.: US 2009/0304033 A1
(43) Pub. Date: Dec. 10, 2009

(54) LASER FOR GENERATING MULTIPLE WAVELENGTHS

(75) Inventors: Hamish Ogilvy, New South Wales (AU); Richard Paul Mildren, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: LIGHTHOUSE TECHNOLOGIES PTY LTD, Macquarie University, New South Wales (AU)

(21) Appl. No.: 12/282,767

(22) PCT Filed: Mar. 13, 2007
(86) PCT No.: PCT/AU2007/000308

§ 371 Date: Feb. 12, 2009

(30) Foreign Application Priority Data
Mar. 13, 2006 (AU) 2006901270

(51) Int. Cl. H01S 3/11; H01S 3/10; H01S 3/08

(52) U.S. Cl. 372/10; 372/23; 372/22; 372/20; 372/99

(57) ABSTRACT

A laser comprising: a first reflector and a second reflector defining a first resonator cavity; a third reflector defining a second resonator cavity with the first reflector; a laser material disposed such that it is located in both the first and the second resonator cavities, the laser material being capable of generating at least a first and a second wavelength of laser light when pumped by pump radiation from a pump source located external to the first and second resonator cavities; wherein the first reflector is adapted to reflect the first wavelength of laser light into the first resonator cavity and the third reflector is adapted to reflect the second wavelength of laser light into the second resonator cavity.

### TECHNICAL FIELD

The present invention relates to a laser system having a shutter for preventing laser light generated by the laser material from passing to a first reflector when shut, and to permit laser light generated by the laser material to pass to the first reflector when open. The invention also relates to a laser system in which at least two different wavelengths of laser light are capable of resonating in spatially separate portions of the laser system. The invention also relates to methods for operating these laser systems.

### BACKGROUND

Altering the wavelength of laser output is important for many applications such as dermatology. Applications may require rapid switching between wavelengths or laser output to be composed of two output wavelengths simultaneously, or sequentially.

Several laser materials are available which may generate more than one wavelength, but to date switching between wavelengths has only achieved by moving or substituting optics in a resonator (e.g. T. Reinhardt, DE3813281). Simultaneous output has also been achieved by balancing the round-trip gain of the two laser transitions to be approximately equal so they will oscillate together. This has been done using adjustable loss components in one resonator arm, by tuning the mirror alignment to adjust the loss of one wavelength, selecting mirror transmissions specifically to equalize the gain, using polarisation splitting to separate and recombine the two wavelengths, varying the cavity length to approximately equalize the round trip gain and using laser materials for which it easier to balance the gain (eg. Nd:YAP).

A major disadvantage of these dual wavelength and wavelength switchable systems is that mirrors or optics need to be moved in and out of the resonator to alter the spectral content, which necessitates the use of substantial high-cost precision opto-mechanical components. Also, wavelength switching can not easily be achieved at high speed.

Sum frequency mixed output has previously been obtained using two completely separate resonators, which are optimized for the 1.06 μm and 1.3 μm transitions respectively and then sum frequency mixed internally or externally. However, these methods are not optimal, as the as they are complex and/or the laser output has limited dynamic range.

### SUMMARY

In a broad form of the invention there is provided a laser system capable of switchably outputting at least two different wavelengths of laser light. The laser system may be a multispatial mode laser system. Switching between different wavelengths may be accomplished without realignment of the optical elements (mirrors, reflectors etc.) of the system. The system may be capable of having at least two different wavelengths of laser beam resonating simultaneously within the system such that they are at least partially spatially separated within the system. The spatial separation may be a lateral separation relative to the longitudinal axis of the system. The spatial separation may be over a part or all of the length of the system. The switching may be accomplished using a wavelength selector. The wavelength selector may comprise a mechanical wavelength selector e.g. a shutter. It will be appreciated by the skilled addressee that the multispatial modes are transverse modes of the laser resonator and the terms “spatial mode” and “transverse mode” may be used interchangeably.

The laser system of the present arrangements may comprise a first reflector and a second reflector defining a first resonator cavity. The laser may further comprise a third reflector defining a second resonator cavity with the first reflector. The laser may further comprise a laser material disposed such that it is located in both the first and the second resonator cavities, the laser material being capable of generating at least a first and a second wavelength of laser light when pumped by pump radiation from a pump source located external to the first and second resonator cavities. In operation, the first reflector may reflect the first wavelength of laser light into the first resonator cavity and the third reflector may reflect the second wavelength of laser light into the second resonator cavity.

The laser may comprise a first reflector and a second reflector defining a first resonator cavity. The laser may further comprise a third reflector defining a second resonator cavity with the first reflector. The laser may further comprise a laser material disposed such that it is located in both the first and the second resonator cavities, the laser material being capable of generating at least a first and a second wavelength of laser light when pumped by pump radiation from a pump source located external to the first and second resonator cavities. In operation, the first and second resonator cavities may have different spatial modes, each spatial mode corresponding to a non-identical gain volume of the laser material, wherein the first wavelength of laser light may resonate in the first resonator cavity and the second wavelength of laser light may resonate in the second resonator cavity.

The laser may comprise a first reflector and a second reflector defining a first resonator cavity. The laser may further comprise a third reflector defining a second resonator cavity with the first reflector. The laser may further comprise a laser material disposed such that it is located in both the first and the second resonator cavities, the laser material being capable of generating at least a first and a second wavelength of laser light when pumped by pump radiation from a pump source located external to the first and second resonator cavities. In operation, the first reflector and the third reflector may provide spatially separated optical feedback to the first and second resonator cavities respectively such that the first wavelength of laser light resonates in the first resonator cavity and the second wavelength of laser light resonates in the second resonator cavity.

In a first aspect there is provided a laser system comprising:

a first reflector and a second reflector defining a first resonator cavity;

a third reflector defining a second resonator cavity with the second reflector;

a laser material disposed such that it is located in both the first and the second resonator cavities, the laser material being capable of generating at least a first and a second wavelength of laser light when pumped by pump radiation from a pump source located external to the first and second resonator cavities;

wherein the first reflector is adapted to reflect the first wavelength of laser light into the first resonator cavity and the third reflector is adapted to reflect the second wavelength of laser light into the second resonator cavity.

In a second aspect, there is provided a laser system comprising:

a first reflector and a second reflector defining a first resonator cavity;

a third reflector defining a second resonator cavity with the first reflector;

a laser material disposed such that it is located in both the first and the second resonator cavities, the laser material being capable of generating at least a first and a second wavelength of laser light when pumped by pump radiation from a pump source located external to the first and second resonator cavities;

wherein the first and second resonator cavities may have different spatial modes, each spatial mode corresponding to a non-identical gain volume of the laser material, wherein the first wavelength of laser light resonates in the first resonator cavity and the second wavelength of laser light resonates in the second resonator cavity.

In a third aspect, there is provided a laser system comprising:

a first reflector and a second reflector defining a first resonator cavity;

a third reflector defining a second resonator cavity with the second reflector;

a laser material disposed such that it is located in both the first and the second resonator cavities, the laser material being capable of generating at least a first and a second wavelength of laser light when pumped by pump radiation from a pump source located external to the first and second resonator cavities;

wherein the first reflector and the third reflector provide spatially separated optical feedback to the first and second resonator cavities respectively such that the reflectivities of the first and the second reflectors are adapted to resonate the first wavelength of laser light resonates in the first resonator cavity and the reflectivities of the second and the third reflectors are adapted to resonate the second wavelength of laser light resonates in the second resonator cavity.

In the arrangement of the laser system according to either the first through third aspects, the first and second wavelengths of laser light may be spatially separated from each other in the laser material such that the first wavelength of laser light resonates in the first resonator cavity and the second wavelength of laser light resonates in the second resonator cavity. The first reflector and the third reflector may be co-located.

The arrangement of the laser system according to either the first through third aspects may further comprising a selection means movable between a first and a second position, wherein when the selection means is in the first position, the second wavelength of laser light may resonate in the second resonator cavity, and when the selection means is in the second position, the first wavelength of laser light may resonate in the first resonator cavity.

The third reflector may be disposed between the first reflector and the laser material and may be transmissive at the first wavelength of laser light generated by the laser material and reflective at the second wavelength of laser light generated by the laser material.

The first and the second resonator cavities may be coaxial and the selection means may be movable between a first position located on the axis of the first and the second resonator cavities and intermediate the first reflector and the third reflector and a second position located removed from the axis of the first and the second resonator cavities.

In the first position the selection means may be disposed so as to prevent laser light generated by the laser material from passing to the first reflector, and in the second position the selection means may be disposed so as to allow laser light generated by the laser material to pass to the first reflector.

The first resonator cavity may be spatially separated from the second resonator cavity such that the first and second wavelengths of laser light are able to resonate in spatially separated regions of the laser material.

The selection means may be continuously movable between the first and the second positions.

The selection means may be intermediate the first and second positions, the first wavelength may resonate in the first resonator cavity and the second wavelength may resonate in the second resonator cavity.

The ratio of the optical power generated at the first and second wavelengths may be variable as the selection means is moved between the first and second positions. The ratio of the optical power generated at the first and second wavelengths may be variable. The ratio of the optical power generated at the first and the second wavelengths may be selectable via the selection means.

The selection means may be a refractive selection means and it may be a transparent prism. The selection means may be a diffuse scatterer selection means. The selection means may alternately be either an electro-optic or an acousto-optic modulator and it may be located in either the first or the second resonator cavity.

In the arrangement of the laser system according to either the first through third aspects, the laser system may further comprise an output coupler adapted for outputting at least a portion of the first and the second wavelengths of laser light. The second reflector may be the output coupler.

The first reflector may be the selection means, and the first mirror may have a composite optical coating on the reflective surface of the first reflector wherein, the coating may be highly reflective at the first wavelength in a first portion of the reflective surface and the coating may be highly reflective at the second wavelength in a first portion of the reflective surface. The first reflector selection means may be laterally translatable with respect to the axis of the first and second resonator cavities.

The first and the third reflector may be co-located on a single composite reflector, the substrate having a composite optical coating. The composite coating may be being highly reflective at the first wavelength in a first portion of the reflective surface and the coating may be highly reflective at the second wavelength in a first portion of the reflective surface. The first portion may correspond to the first reflector, and the second portion may correspond to the third reflector.

The composite reflector may be a selection means and may be laterally translatable with respect to the axis of the first and second resonator cavities between a first and a second position, wherein when the selection means is in the first position, the second wavelength of laser light may resonate in the second resonator cavity, and when the selection means is in the second position, the first wavelength of laser light may resonate in the first resonator cavity. The first portion of the reflective surface may be adjacent and coplanar to the second portion of the reflective surface. The first portion of the reflective surface may comprise a region surrounding and coplanar with the second portion of the reflective surface. The second portion of the reflective surface may comprise a region surrounding and coplanar with the first portion of the reflective surface. The first portion of the reflective surface may comprise an annular region concentric with a centrally located circular region comprising the second portion of the reflective surface. The second portion of the reflective surface may comprise an annular region concentric with a centrally located circular region comprising the first portion of the reflective surface. The composite reflector selection means may be intermediate the first and second positions, and the first wavelength may resonate in the first resonator cavity and the second wavelength may resonate in the second resonator cavity.

The selection means may further comprise an variable aperture with radius continuously adjustable between a first and second radius position, wherein when the variable aperture is in the first radius position, the laser light generated by the laser material may be allowed to impinge on the central region and prevented from impinging on the annular region of the reflective surface of the first reflector selection means, and in the second radius position, the laser light generated by the laser material may be allowed to impinging on both the central region and the annular region of the reflective surface of the first reflector selection means.

In the arrangement of the laser system according to either the first through third aspects, the laser may further comprises a Q-switch located in the first resonator cavity and the second cavity for generation of pulsed laser light at both the first and the second wavelengths of laser light.

In the arrangement of the laser system according to either the first through third aspects, the laser may further comprise a mode-locked laser.

In the arrangement of the laser system according to either the first through third aspects, the laser may further comprise a nonlinear material located in the first and the second resonator cavities, wherein the nonlinear material may be phase-matched for frequency conversion of either or both of the first and the second wavelength of laser light to generate laser light at a frequency converted wavelength.

The nonlinear material frequency may convert the first or the second wavelengths of laser light by second harmonic generation. The nonlinear material frequency may convert the first and the second wavelengths of laser light simultaneously by either second harmonic generation, sum frequency generation or difference frequency generation.

The laser may further comprise an output coupler adapted for outputting at least a portion of either the first or the second wavelengths of laser light and at least a portion of the frequency converted wavelength of laser light.

The first wavelength may be between approximately 1060 and 1070 nm and the second wavelength may be between approximately 1310 and 1340 nm. The nonlinear material may be phase-matched to frequency convert the first wavelength to generate a frequency converted wavelength between approximately 530 and 535 nm. The nonlinear material may be phase-matched to frequency convert the second wavelength to generate a frequency converted wavelength between approximately 655 and 670 nm.

The non-linear medium may be capable of second harmonic generation (frequency doubling, SHG), sum frequency generation (SFG) or difference frequency generation (DFG) or some other non-linear frequency conversion.

The non-linear medium may be tunable so as to perform SHG, SFG or DFG selectively for frequency converting at least one of the first and second wavelengths of laser light, the laser further comprising a tuner for tuning the non-linear medium.

The nonlinear material may be tunable to selectively frequency convert at least one of the first and second wavelengths of laser light to generate a frequency converted wavelength selected from the group of the second harmonic wavelength of the first wavelength, the second harmonic wavelength of the second wavelength or the sum-frequency wavelength of the first and the second wavelengths.

The second harmonic of the first wavelength may be in the range of 530 to 535 nm, the second harmonic of the second wavelength may be in the range of 655 and 670 nm, and the sum frequency wavelength may be in the range of 585 to 600 nm.

The nonlinear material may be either temperature tuned or angle tuned.

The laser system may further comprise at least one additional reflector located in the first and the second resonator cavities to define a folded resonator cavity. The laser may comprise one additional reflector. The laser may comprise two additional reflectors to define a Z-fold resonator cavity for either or both the first or the second resonator cavities. The additional reflector(s) may be located intermediate the laser material and the nonlinear material.

In the arrangement of the laser system according to either the first through third aspects, the laser may further comprises an etalon located in either the first or the second resonator cavity.

In the arrangement of the laser system according to either the first through third aspects, the laser may be a solid-state laser. The laser may comprise a single pump source for pumping the laser material. The pump source may pump a single pump region of the laser resonator and the first and the second resonator cavities may access spatially separated regions of the single pump region.

In an arrangement, either the first reflector or the third may be smaller than the third reflector. The cross-sectional radial extent of either the first or the third reflector may be less than the cross-sectional radial extent of the laser material. The centre of either the first or the third reflector is located on the axis of the laser material.

In an arrangement of the laser system according to either the first through third aspects the laser may comprise a plurality of additional reflectors defining a corresponding plurality of additional resonators, each additional resonator adapted to resonate a corresponding plurality of additional wavelengths of laser light.

In an arrangement of the laser system according to either the first through third aspects the laser may comprise a plurality of additional reflectors defining a corresponding plurality of additional resonators, each additional resonator adapted to resonate a corresponding plurality of additional wavelengths of laser light; and a plurality of selection means each movable between a first and a second position; wherein the second reflector is adapted to output the first, second and the additional wavelengths of laser light, and the wavelength of laser light that is output is selectable by the relative positions of each of the selection means.

In a fourth aspect, there is provided a method for generating a desired wavelength of laser light, comprising:

a) providing a laser according to any one of the first through third aspects;

b) pumping the laser material of the laser system so as to generate laser light at a first and a second wavelength;

c) moving the selection means so as to select either the first or the second wavelength of laser light; and

d) outputting the selected wavelength of laser light from the laser.

In an arrangement of the fourth aspect there is provided a method for generating a desired wavelength of laser light, comprising:

a) providing a laser comprising a first reflector and a second reflector defining a first resonator cavity; a third reflector defining a second resonator cavity with the second reflector; a laser material disposed such that it is located in both the first and the second resonator cavities, the laser material being capable of generating at least a first and a second wavelength of laser light when pumped by pump radiation from a pump source located external to the first and second resonator cavities; wherein the first reflector is adapted to reflect the first wavelength of laser light into the first resonator cavity and the third reflector is adapted to reflect the second wavelength of laser light into the second resonator cavity;

b) pumping the laser material of the laser system so as to generate laser light at a first and a second wavelength;

c) moving the selection means so as to select either the first or the second wavelength of laser light; and

d) outputting the selected wavelength of laser light from the laser.

In a further arrangement of the fourth aspect there is provided a method for generating a desired wavelength of laser light, comprising

a) providing a laser comprising a first reflector and a second reflector defining a first resonator cavity; a third reflector defining a second resonator cavity with the first reflector; a laser material disposed such that it is located in both the first and the second resonator cavities, the laser material being capable of generating at least a first and a second wavelength of laser light when pumped by pump radiation from a pump source located external to the first and second resonator cavities; wherein the first and second resonator cavities may have different spatial modes, each spatial mode corresponding to a non-identical gain volume of the laser material, wherein the first wavelength of laser light resonates in the first resonator cavity and the second wavelength of laser light resonates in the second resonator cavity;

b) pumping the laser material of the laser system so as to generate laser light at a first and a second wavelength;

c) moving the selection means so as to select either the first or the second wavelength of laser light; and

d) outputting the selected wavelength of laser light from the laser.

In a further arrangement of the fourth aspect there is provided a method for generating a desired wavelength of laser light, comprising

a) providing a laser comprising a first reflector and a second reflector defining a first resonator cavity; a third reflector defining a second resonator cavity with the second reflector; a laser material disposed such that it is located in both the first and the second resonator cavities, the laser material being capable of generating at least a first and a second wavelength of laser light when pumped by pump radiation from a pump source located external to the first and second resonator cavities; wherein the first reflector and the third reflector provide spatially separated optical feedback to the first and second resonator cavities respectively such that the reflectivities of the first and the second reflectors are adapted to resonate the first wavelength of laser light resonates in the first resonator cavity and the reflectivities of the second and the third reflectors are adapted to resonate the second wavelength of laser light resonates in the second resonator cavity

b) pumping the laser material of the laser system so as to generate laser light at a first and a second wavelength;

c) moving the selection means so as to select either the first or the second wavelength of laser light; and

d) outputting the selected wavelength of laser light from the laser.

Step (d) may alternately comprise frequency converting the selected wavelength of laser light in a nonlinear material to generate frequency converted laser light and outputting the frequency converted laser light from the laser.

The outputted wavelength may be the frequency converted wavelength of selected wavelength of laser light.

The laser may comprise a non-linear medium for frequency converting one or more wavelengths of laser light resonating in the system, and the method may further comprise:

tuning the non-linear medium to selectively frequency convert at least one of the first or second wavelengths of laser light by either second harmonic generation (SHG), sum frequency generation (SFG) or difference frequency generation (DFG); and

using the non-linear medium to convert at least one of the first or second wavelengths of laser light into a laser light at a frequency converted wavelength one for output from the laser.

In a fifth aspect, there is provided a method for selecting the ratio of intensities of two wavelengths in a laser beam, comprising:

providing a laser according to any one of the first through thirds aspects;

pumping the laser material so as to generate at least two different wavelengths of laser light;

moving the selection means so as to select the ratio of intensities of the two wavelengths; and

outputting the laser beam having the selected ratio of intensities of the two wavelengths from the laser.

In an arrangement of the fifth aspect there is provided a method for generating a desired wavelength of laser light, comprising:

providing a laser comprising a first reflector and a second reflector defining a first resonator cavity; a third reflector defining a second resonator cavity with the second reflector; a laser material disposed such that it is located in both the first and the second resonator cavities, the laser material being capable of generating at least a first and a second wavelength of laser light when pumped by pump radiation from a pump source located external to the first and second resonator cavities; wherein the first reflector is adapted to reflect the first wavelength of laser light into the first resonator cavity and the third reflector is adapted to reflect the second wavelength of laser light into the second resonator cavity;

pumping the laser material so as to generate at least two different wavelengths of laser light;

moving the selection means so as to select the ratio of intensities of the two wavelengths; and

outputting the laser beam having the selected ratio of intensities of the two wavelengths from the laser.

In a farther arrangement of the fifth aspect there is provided a method for generating a desired wavelength of laser light, comprising

a) providing a laser comprising a first reflector and a second reflector defining a first resonator cavity; a third reflector defining a second resonator cavity with the first reflector; a laser material disposed such that it is located in both the first and the second resonator cavities, the laser material being capable of generating at least a first and a second wavelength of laser light when pumped by pump radiation from a pump source located external to the first and second resonator cavities; wherein the first and second resonator cavities may have different spatial modes, each spatial mode corresponding to a non-identical gain volume of the laser material, wherein the first wavelength of laser light resonates in the first resonator cavity and the second wavelength of laser light resonates in the second resonator cavity;

pumping the laser material so as to generate at least two different wavelengths of laser light;

moving the selection means so as to select the ratio of intensities of the two wavelengths; and

outputting the laser beam having the selected ratio of intensities of the two wavelengths from the laser.

In a further arrangement of the fifth aspect there is provided a method for generating a desired wavelength of laser light, comprising providing a laser comprising a first reflector and a second reflector defining a first resonator cavity; a third reflector defining a second resonator cavity with the second reflector; a laser material disposed such that it is located in both the first and the second resonator cavities, the laser material being capable of generating at least a first and a second wavelength of laser light when pumped by pump radiation from a pump source located external to the first and second resonator cavities; wherein the first reflector and the third reflector provide spatially separated optical feedback to the first and second resonator cavities respectively such that the reflectivities of the first and the second reflectors are adapted to resonate the first wavelength of laser light resonates in the first resonator cavity and the reflectivities of the second and the third reflectors are adapted to resonate the second wavelength of laser light resonates in the second resonator cavity;

pumping the laser material so as to generate at least two different wavelengths of laser light;

moving the selection means so as to select the ratio of intensities of the two wavelengths; and

outputting the laser beam having the selected ratio of intensities of the two wavelengths from the laser.

The method may be for treating, detecting or diagnosing a selected area on or in a subject requiring such diagnosis or treatment, comprising illuminating the selected area with an output laser beam from the laser.

The laser may be a pulsed laser and the method may comprise:

a) selecting a first wavelength of output laser light using the selection means;

b) illuminating the selected area with a desired number of pulses of the output laser light at the first wavelength;

c) selecting a second wavelength of output laser light;

d) illuminating the selected area with a desired number of pulses of the output laser light at the second wavelength;

e) repeating steps (a) to (d) as required for the treatment, detection or diagnosis.

The selected area may be illuminated with a laser beam having a wavelength, and for a time and at a power level, as appropriate and effective for the diagnosis or therapeutically effective for the treatment.

Step (a) of the method may comprise selecting a first wavelength of laser light using the selection means and frequency converting the first wavelength in a nonlinear material to generate frequency converted output laser light; and step (b) may comprise illuminating the selected area with a desired number of pulses of the frequency converted output laser light.

The laser material may be a solid state laser material having a neodymium active ion and the first wavelength of output laser light may have a wavelength in the range of approximately 1060 to 1065 nm; and the second wavelength of output laser light may have a wavelength in the range of approximately 1320 to 1340 nm.

The laser material may be a solid state laser material having a neodymium active ion and the first wavelength of laser light may have a wavelength in the range of approximately 1060 to 1065 nm which is frequency converted to generate the frequency converted output laser light at a wavelength of approximately 530 to 533 nm; and the second wavelength of output laser light may have a wavelength in the range of approximately 1320 to 1340 nm.

The method may be used for the treatment of acne.

In a sixth aspect there is provided a laser system comprising:

a first reflector, a second reflector and a third reflector;

a laser material disposed between the first reflector and the second reflector, said laser material being capable of generating at least two different wavelengths of laser light when pumped by pump radiation; and

a shutter disposed within the system so as to prevent laser light generated by the laser material from passing to the first reflector when shut, and to permit laser light generated by the laser material to pass to the first reflector when open;

wherein the third reflector is disposed such that, when the shutter is open, laser light generated by the laser material can resonate in a cavity formed between the first and second reflectors, and, when the shutter is shut, laser light generated by the laser material can resonate in a cavity formed between the second and third reflectors.

The third reflector may be disposed between the shutter and the laser material. The shutter may be located between the first and third reflectors. In use, when the shutter is open, one wavelength of laser light generated by the laser material may resonate in the system, and when the shutter is closed a different wavelength of laser light may resonate in the system. The first reflector may be highly reflective towards a first wavelength of laser light generated by the laser material, optionally that wavelength generated at highest gain by the laser material. The third reflector may be highly reflective towards a second wavelength of laser light generated by the laser material. The second wavelength may be generated by the laser material at lower gain than the first wavelength. In some arrangements the third reflector may be transmissive, optionally highly transmissive, towards the first wavelength. The second reflector may be at least partially reflective towards both the first and second wavelengths. When the shutter is open, laser light may be capable of passing through said shutter.

The laser system may be capable of switchably outputting the at least two different wavelengths of laser light. It may be capable of switchably outputting each wavelength separately or simultaneously. The laser material may be capable of generating the at least two different wavelengths of laser light with different gains. The second reflector may comprise an output coupler, or there may be a separate output coupler disposed in the system for outputting one or more desired wavelengths of laser light. The system may also comprise a pump source for pumping the laser material. The pump source may be capable of end-pumping or side pumping the laser material. The pump source may be a diode laser pump source, a flashlamp pump source or some other pump source. The system may comprise a Q-switch for converting continuous laser light into pulsed laser light.

In an arrangement there is provided a laser system comprising:

a first reflector and a second reflector;

a laser material disposed between the first and second reflectors, said laser material being capable of generating at least two different wavelengths of laser light when pumped by pump radiation;

a third reflector disposed between the first reflector and the laser material, said third reflector being transmissive towards a first wavelength of laser light generated by the laser material and reflective towards a second wavelength of laser light generated by the laser material; and

a shutter disposed between the first reflector and the third reflector so as to prevent laser light generated by the laser material from passing to the first reflector when shut, and to permit laser light to pass to the first reflector when open;

wherein, when the shutter is open, the first wavelength of laser light can resonate in the cavity formed by the first and second reflectors, and, when the shutter is shut, the second wavelength of laser light can resonate in the cavity formed by the second reflector and the third reflector. The first wavelength may be generated by the laser material at higher gain than the second wavelength.

If the shutter is in a condition between open and shut, both the first and second wavelengths may resonate in the system and they may resonate in the laser system simultaneously. They may have different spatial modes spatially separated at some locations within the resonator. The different spatial modes may be laterally separated with respect to the longitudinal axis of the laser system for at least a part of the length of the laser system.

In operation, the pump radiation (or pump light) is directed to the laser material and thereby causes the laser material to generate at least two different wavelengths of laser light when pumped by the pump radiation. When the shutter is open, the first wavelength is capable of resonating between the first and second reflectors, as the third reflector is transmissive to the first wavelength. In doing so, the first wavelength will predominate (as it is produced with highest effective gain), and energy will be extracted from the laser material at the first wavelength, such that it will be the resonating wavelength, which may be outputted from the system. When the shutter is closed, the first wavelength experiences significant resonator loss, as it is not reflected by the third reflector, and is prevented, or blocked, from reaching the first reflector by the shutter. Accordingly (in the case of laser gain media for which there is gain competition between the first and second wavelengths), the energy of the second wavelength (the second wavelength exhibiting lower intrinsic gain than the first wavelength) will be extracted from the laser material, and it will be the second wavelength that resonates within the system and may be outputted from the system. Thus the second wavelength will exhibit higher effective gain than the first wavelength, so that stimulated emission extracts the second wavelength from the population inversion in the laser material before it can contribute to stimulated emission of other transitions, which exhibit lower effective gain due to significant resonator loss. The shutter may also be in a partially open (or partially shut) condition. In this case, in a first portion of system, the first wavelength will reach the first reflector, and will resonate as described above. In a second portion of the system, laterally separated from the first portion, the first wavelength will be blocked by the shutter from reaching the first reflector, and consequently the second wavelength will resonate in the system as described above. Thus in this case two wavelengths will resonate in the system in portions of the system that are laterally separated from each other over at least a portion of the length of the system.

In another arrangement there is provided a laser system comprising:

a first reflector, a second reflector, a third reflector and a fourth reflector;

a laser material disposed between the first reflector and the second reflector, said laser material being capable of generating at least three different wavelengths of laser light when pumped by pump radiation;

a first shutter disposed within the system so as to prevent laser light generated by the laser material from passing to the first reflector when shut, and to permit laser light generated by the laser material to pass to the first reflector when open; and

a second shutter disposed within the system so as to prevent laser light generated by the laser material from passing to the fourth reflector when said second shutter is shut and the first shutter is open, and to permit laser light generated by the laser material to pass to the first reflector when both the first and second shutters are open;

wherein the third reflector is disposed such that, when the first shutter is open and the second shutter is closed, laser light generated by the laser material can resonate in a cavity formed between the first and second reflectors, and, when the first shutter is shut, laser light generated by the laser material can resonate in a cavity formed between the second and third reflectors, and wherein the fourth reflector is disposed such that, when the first and second shutters are both open, laser light generated by the laser material can resonate in a cavity formed between the fourth and second reflectors.

The first reflector may be reflective towards a first wavelength of laser light generated by the laser material and transmissive towards a third wavelength of laser light generated by the laser material. The third wavelength may be that wavelength generated at highest gain by the laser material. The third reflector may be highly reflective towards a second wavelength of laser light generated by the laser material. The second wavelength may be generated by the laser material at lower gain than the first wavelength. The third reflector may be transmissive towards the first wavelength and the third wavelength. The second reflector may be at least partially reflective towards both the first, second and third wavelengths. The fourth reflector may be highly reflective towards the third wavelength.

In operation, the pump radiation is directed to the laser material and thereby causes the laser material to generate at least three different wavelengths of laser light when pumped by the pump radiation. When the first and second shutters are open, the third wavelength is capable of resonating between the fourth and second reflectors, as the first and third reflectors are transmissive to the third wavelength. In doing so, that wavelength will predominate (as it is produced with highest gain of the three wavelengths), and energy will be preferentially extracted from the laser material at the third wavelength, such that it will be the resonating wavelength, which may be outputted from the system. When the second shutter is closed and the first shutter is open, the third wavelength is not capable of resonating, as it is not reflected by the first or third reflector, and is prevented, or blocked, from reaching the fourth reflector by the second shutter. Accordingly, energy will be preferentially extracted from the laser material at the first wavelength, which is reflected by the first reflector and transmitted by the third reflector (said first wavelength being generated at lower gain than the third wavelength), and it will be the first wavelength that resonates within the system and may be outputted from the system. When the first and second shutters are both closed, the first wavelength is not capable of resonating, as it is not reflected by the third reflector, and is prevented from reaching the first reflector by the first shutter. As described above, the third wavelength can not resonate due to the second (and first) shutter being closed. Accordingly the energy will be preferentially extracted from the laser material at the second wavelength, which is reflected by the third reflector (said wavelength being generated at lower gain than the first wavelength and the third wavelength), and it will be the second wavelength that resonates within the system and may be outputted from the system. The first and/or second shutter may also be in a partially open (or partially shut) condition. In this case, similarly to the case of a single shutter, as described above, two or three wavelengths may resonate in the system simultaneously, in laterally separated portions of the system.

In another arrangement there is provided a laser system comprising:

a first reflector and a second reflector;

a laser material disposed between the first and second reflectors, said laser material being capable of generating at least two different wavelengths of laser light when pumped by pump radiation;

a third reflector, said third reflector having low reflectivity towards a first wavelength of laser light, said first wavelength being that wavelength generated by the laser material with highest gain, and said third reflector being reflective towards a second wavelength of laser light, said third reflector being disposed such that, if laser light generated by the laser material impinges on both the first and third reflectors, laser light reflected from the first reflector and laser light reflected from the third reflector will be spatially separated in at least a portion of the laser system; and

a shutter disposed between the first reflector and the laser material so as to prevent laser light generated by the laser material from passing to the first reflector and to permit laser light generated by the laser material to pass to the third reflector when shut, and to permit laser light generated by the laser material to pass to the first reflector and to the third reflector when open;

wherein, when the shutter is open, laser light generated by the laser material can resonate in the cavity formed by the first and second reflectors, and can also resonate in the cavity formed by the second and third reflectors, and when the shutter is closed, laser light generated by the laser material can resonate in the cavity formed by the second and third reflectors but can not resonate in the cavity formed by the first and second reflectors.

The first reflector and the third reflector may be coplanar or may be non-coplanar. They may be concentric. They may or may not be longitudinally separated. They may or may not be laterally separated. They may be longitudinally separated and laterally separated.

In operation, when the shutter is shut, laser light from the laser material is permitted to reach the third reflector but not the first reflector. Therefore the first wavelength is not capable of resonating in the system, as it is not reflected by the third reflector. The second wavelength, which is generated by the laser material at lower gain than the first wavelength, is permitted to reach the third reflector, and is reflected by it, and consequently can resonate within the cavity. When the shutter is open, the second wavelength resonates as described above. Additionally, the first wavelength is permitted to reach the first reflector, and consequently resonates within a portion of the system. In that portion, since the first wavelength is generated at highest gain, the energy of other wavelengths will be diverted into the first wavelength, which will then dominate within that portion of the system.

In one example, the third reflector comprises a circular region and the first reflector comprises a region surrounding and coplanar with the third reflector, for example an annular region concentric with the circular region. The third reflector in this case may be transmissive towards the first wavelength. In this case the shutter may be in the form of a variable sized aperture, such that when open, laser light generated by the laser material passes to both the first and third reflectors, and when closed, laser light generated by the laser material passes to only the third reflector.

In another example, the first reflector comprises a reflective coating on a first side of a mirror substrate and the third reflector comprises a circular coating on a second side of the substrate such that the third reflector is smaller than, and concentric with, the first reflector, and the second side of the substrate is that side nearer the laser material.

In another example the first and third reflectors may comprise semicircular reflectors which abut to form a circle. Translation of this combined mirror in a lateral direction can effectively change the proportion of each wavelength in the output.

In another arrangement there is provided a laser system comprising:

a first reflector and a second reflector;

a laser material disposed between the first and second reflectors, said laser material being capable of generating at least two different wavelengths of laser light when pumped by pump radiation;

a third reflector, said third reflector having low reflectivity, towards a first wavelength of laser light generated by the laser material, said first wavelength being that wavelength generated by the laser material with highest gain, and said third reflector being reflective towards a second wavelength of laser light generated by the laser material, said third reflector comprising an annular region and the first reflector comprising an annular region surrounding, coplanar and concentric with the third reflector;

a fourth reflector, said fourth reflector having low reflectivity, and optionally low transmissivity, towards the first wavelength of laser light and towards the second wavelength of laser light and being reflective towards a third wavelength of laser light, said third wavelength being generated by the laser material with gain less than either the first or second wavelengths, said fourth reflector being surrounded by and coplanar with the third reflector,

a shutter disposed between the first reflector and the laser material so as to prevent laser light generated by the laser material from passing to the first or third reflectors and to permit laser light generated by the laser material to pass to the fourth reflector when shut, to permit laser light generated by the laser material to pass to the third and fourth reflectors but not to the first reflector when in an intermediate condition, and to permit laser light generated by the laser material from reaching the first reflector when open;

wherein, when the shutter is open, laser light generated by the laser material can resonate in the cavity formed by the first and second reflectors and in the cavity formed by the second and third reflectors and in the cavity formed by the second and fourth reflectors, when the shutter is in the intermediate condition, laser light generated by the laser material can resonate in the cavity formed by the second and third reflectors and in the cavity formed by the second and fourth reflectors but not in the cavity formed by the first and second reflectors, and when the shutter is shut, laser light generated by the laser material can resonate in the cavity formed by the second and fourth reflectors but can not resonate in the cavity formed by the first and second reflectors or in the cavity formed by the second and third reflectors.

In a similar fashion to the arrangements described above, the shutter may be used to select the wavelength or wavelengths that will resonate in the system. If more than one wavelength resonates, the wavelengths may resonate in spatially separated portions of the system, which may be laterally separated portion. Thus the first second and third wavelengths may resonate in concentric portions, or the second and third wavelengths may resonate in concentric portions, or only the third wavelength may resonate in the system.

It will be understood from the foregoing arrangements and examples that more than two wavelengths may be switchably outputted by the arrangements of the laser system, and that in certain arrangements a plurality of wavelengths may be also selected for output, said wavelengths being optionally spatially separated as they are outputted.

In another arrangement there is provided a laser system capable of selectively outputting m different wavelengths of output laser beam, where m is an integer greater than 1, said system having a first end and a second end, and said system comprising:

a laser material located in the system and capable of generating n different wavelengths of cavity laser beam, where n is an integer greater than or equal to m;

a first reflector reflective to the first wavelength of cavity laser beam, said first reflector being located at the first end of the system;

an end reflector located at the second end of the system;

second to mth reflector(s) wherein, for each p between 2 and m inclusive, the pth reflector is reflective to the pth wavelength of cavity laser beam and has low reflectivity towards the 1st to (p−1)th wavelengths of cavity laser beam, each of said second to mth reflector(s) being located either coplanar with and spatially separate from the (p−1)th reflector or between the (p−1)th reflector and the laser material; and

a wavelength selector, comprising at least one shutter and capable of selecting at least one of the m different wavelengths of cavity laser beam for output without altering the alignment of the reflectors;

wherein for each p, the pth wavelength is usually generated by the laser material at greater gain than, or similar to, the (p+1)th wavelength.

In this arrangement, m may be greater than 2, 3, 4, 5, 10, 15 or 20, and may be for example between 2 and about 25, or between 5 and 25, 10 and 25, 2 and 10 or 5 and 10, and may be for example 2, 3, 4, 5, 6, 7, 8, 9, 10, 11, 12, 13, 14, 15, 16, 17, 18, 19, 20, 21, 22, 23, 24 or 25 or more than 25. n may be between 2 and about 10, or between 2 and 8, 2 and 6, 2 and 4, 4 and 10, 6 and 10 or 4 and 8, and may be for example 2, 3, 4, 5, 6, 7, 8, 9 or 10.

The end reflector may comprise an output coupler. Alternatively a separate output coupler may be located within the cavity. The end reflector may be at least partially reflective towards all of the wavelengths of cavity laser beam resonating in the system.

An arrangement of the present laser system may also comprise a non-linear medium. The non-linear medium may be capable of second harmonic generation (frequency doubling, SHG), sum frequency generation (SFG) or difference frequency generation (DFG) or some other non-linear frequency conversion. The non-linear medium may be tunable so as to perform SHG, SFG or DFG selectively. The tuning may be temperature tuning or angle tuning. The system may have a tuner for tuning the non-linear medium. The system may have a temperature controller for controlling the temperature of the non-linear medium. The temperature controller may be a temperature tuner. The tuner may be disposed within the system so as to be capable of converting one or more wavelengths resonating in the system into a single output wavelength by second harmonic generation (SHG), sum frequency generation (SFG) or difference frequency generation (DFG).

In another arrangement there is provided a laser system for switchably outputting a plurality of different wavelengths of laser light, said laser system comprising:

a first reflector, a second reflector and a third reflector;

a laser material disposed between the first reflector and the second reflector, said laser material being capable of generating at least two different wavelengths of laser light when pumped by pump radiation;

a shutter disposed within the system so as to prevent laser light generated by the laser material from passing to the first reflector when shut, and to permit laser light generated by the laser material to pass to the first reflector when open; and

a non-linear medium disposed such that the non-linear medium is capable of converting one or more wavelengths resonating in the system into a single output wavelength by second harmonic generation (SHG), sum frequency generation (SFG) or difference frequency generation (DFG);

wherein, the third reflector is disposed such that, when the shutter is open, laser light generated by the laser material can resonate in a cavity formed between the first and second reflectors, and, when the shutter is shut, laser light generated by the laser material can resonate in a cavity formed between the second and third reflectors, and when the shutter is in an intermediate condition, a first wavelength of laser light generated by the laser material can resonate in the cavity formed by the first and second reflectors and a second wavelength of laser light generated by the laser material can resonate in the cavity formed by the second reflector and a third reflector.

Commonly when the laser system comprises a non-linear medium, at least one folding mirror may also be present. Thus the laser system may be linear, but may alternatively be folded or Z-shaped, or some other convenient configuration.

In another arrangement there is provided a laser system comprising:

a first reflector, a second reflector, a third reflector and a fourth reflector;

a laser material disposed between the first reflector and the second reflector, said laser material being capable of generating at least two different wavelengths of laser light when pumped by pump radiation; and

a shutter disposed within the system so as to prevent laser light generated by the laser material from passing to the first reflector when shut, and to permit laser light generated by the laser material to pass to the first reflector when open;

wherein the third and fourth reflectors are disposed such that, when the shutter is open, laser light generated by the laser material can resonate in a cavity formed between the first and second reflectors, and, when the shutter is shut, laser light generated by the laser material can resonate in a cavity formed between the second and third reflectors and in a cavity formed between the second and fourth reflectors.

In an example of this arrangement, the first reflector is highly reflective towards the highest gain wavelength (the first wavelength) and the second reflector is partially reflective towards all wavelengths of interest generated by the laser material. The third and fourth reflectors may be located between the first reflector and the laser material. The third reflector in this case is highly reflective towards the first wavelength, and the fourth reflector is transmissive towards the highest gain wavelength and highly reflective towards a second (lower gain) wavelength generated by the laser material. Both the third and fourth reflectors are located between the shutter (in its shut position) and the laser material, and are disposed so that laser light from the laser material can reach at least a portion of both the third and fourth reflectors simultaneously.

In operation, when the shutter is closed, laser light reflects from both the third and fourth reflectors in spatially separated portions of the system. Only the second wavelength can resonate in that portion of the system where the laser light from the laser material reaches the fourth reflector, as it does not reflect the first wavelength and can not reach the first reflector due to the shut shutter. In that portion where the laser light form the laser material reaches the third reflector, that wavelength will resonate. Thus with the shutter shut, both first and second wavelengths can resonate in spatially separate portions of the system. With the shutter open, the first wavelength can pass through the fourth reflector to the first reflector, and consequently the first wavelength can resonate throughout the system. Thus the shutter can cause the system to switch from a single wavelength output (shutter open) to two spatially separated wavelengths (shutter open).

In a seventh aspect there is provided a method for generating a desired wavelength or wavelengths of laser light, comprising:

providing a laser system according to the sixth aspect;

pumping the laser material of the laser system so as to generate at least two different wavelengths of laser light;

moving the shutter or shutters so as to select a desired wavelength or wavelengths of laser light for output from the system; and

outputting the selected wavelength or wavelengths of laser light from the system.

The outputting may be through the second reflector of the laser system, performing the function of output coupler, or may be through a separate output coupler. If the laser system comprises a non-linear medium for wavelength converting one or more wavelengths of laser light resonating in the system, the method may additionally comprise:

tuning the non-linear medium so as to be capable of converting one or more wavelengths resonating in the system into a single output wavelength by second harmonic generation (SHG), sum frequency generation (SFG) or difference frequency generation (DFG); and

using the non-linear medium to convert one or more wavelengths resonating in the system into the desired wavelength laser light for output from the system, said converting being by SHG, SFG or DFG.

In one example arrangement, there is provided a process for generating a desired wavelength of laser light, comprising:

providing a laser system according to the sixth aspect, said system comprising a non-linear medium disposed such that the non-linear medium is capable of converting one or more wavelengths resonating in the system into a single output wavelength by second harmonic generation (SHG), sum frequency generation (SFG) or difference frequency generation (DFG);

pumping the laser material of the laser system so as to generate at least two different wavelengths of laser light;

moving the shutter or shutters of the laser system so as to select a desired wavelength or wavelengths of laser light for output from the system;

tuning the non-linear medium so as to be capable of converting one or more wavelengths resonating in the system into a single output wavelength by second harmonic generation (SHG), sum frequency generation (SFG) or difference frequency generation (DFG);

using the non-linear medium to convert one or more wavelengths resonating in the system into the desired wavelength laser light for output from the system, said converting being by SHG, SFG or DFG; and

outputting the desired wavelength of laser light converted by the non-linear medium from the system.

In a eighth aspect there is provided a method for selecting the ratio of intensities of two wavelengths in a laser beam, comprising:

providing a laser system according to the first aspect;

pumping the laser material so as to generate at least two different wavelengths of laser light;

moving the shutter so as to select the ratio of intensities of the two wavelengths; and

outputting the laser beam having the selected ratio of intensities of the two wavelengths from the system.

In a ninth aspect there is provided a laser system comprising:

a first reflector, a second reflector and a third reflector; and

a laser material disposed between the first reflector and the second reflector, said laser material being capable of generating at least two different wavelengths of laser light when pumped by pump radiation;

wherein the first, second and third reflectors are disposed so that the at least two different wavelengths of laser light are capable of resonating in spatially separate, optionally laterally separate, portions of the laser system.

The laser material may be capable of generating the at least two different wavelengths of laser light with different gains. The second reflector may comprise an output coupler, or there may be a separate output coupler disposed in the system for outputting one or more desired wavelengths of laser light. The system may also comprise a pump source for pumping the laser material. The pump source may be capable of end-pumping or side pumping the laser material. The pump source may be a diode laser pump source, a flashlamp pump source or some other pump source. The system may comprise a Q-switch for converting continuous laser light into pulsed laser light.

In an arrangement, the laser system also comprises a movable shutter disposed within the system so as to prevent laser light generated by the laser material from passing to the first reflector when shut, and to permit laser light generated by-the laser material to pass to the first reflector when open, wherein the third reflector is disposed such that, when the shutter is partially open (or partially shut), laser light of a first wavelength generated by the laser material can resonate in a cavity formed between the first and second reflectors, and laser light of a second wavelength generated by the laser material can resonate in a cavity formed between the second and third reflectors such that the first and second wavelengths resonate in spatially separated portions of the laser system.

The third reflector may be disposed between the shutter and the laser material. The shutter may be located between the first and third reflectors. In use, when the shutter is open, one wavelength of laser light generated by the laser material may resonate in the system, and when the shutter is closed a different wavelength of laser light may resonate in the system. When the shutter is partially open (or partially shut), in a first portion of the laser system, laser light from the laser material is capable of passing to the first reflector, and can resonate in a cavity formed between the first and second reflectors. In this portion of the system, the highest gain wavelength dominates. In a second portion of the laser system, spatially separated from the first portion, the highest gain wavelength can not resonate as it is blocked by the partially open shutter and is not reflected by the third reflector. As a consequence, a different wavelength (of lower gain) can resonate in that portion of the system, as it is reflected by the third reflector, and is thus not blocked by the shutter.

The first reflector may be highly reflective towards a first wavelength of laser light generated by the laser material, optionally that wavelength generated at highest gain by the laser material. The third reflector may be highly reflective towards a second wavelength of laser light generated by the laser material. The second wavelength may be generated by the laser material at lower gain than the first wavelength. In some arrangements the third reflector may be transmissive, optionally highly transmissive, towards the first wavelength. The second reflector may be at least partially reflective towards both the first and second wavelengths. When the shutter is open, laser light may be capable of passing through said shutter.

In another arrangement, the first and third reflectors are laterally separated, so as to form, with the second reflector, two laterally separated resonator cavities. They may be for example concentric. They may be coplanar or non-coplanar.

In a tenth aspect there is provided a method for generating a desired wavelength or wavelengths of laser light, comprising:

providing a laser system according to the ninth aspect;

pumping the laser material of the laser system so as to generate at least two different wavelengths of laser light which resonate in spatially separate portions of the system; and

outputting a wavelength or wavelengths of laser light selected from the group consisting of the at least two different wavelengths of laser light and a wavelength of laser light generated by frequency summing at least two of the different wavelengths of laser light generated by the laser material.

In an eleventh aspect there is provided a method of using a laser system according to the above aspects and arrangements for treating, detecting or diagnosing a selected area on or in a subject requiring such diagnosis or treatment, comprising illuminating the selected area with the output laser beam from the laser system. The selected area may be illuminated with a laser beam having a wavelength, and for a time and at a power level, which is appropriate and effective for the diagnosis or therapeutically effective for the treatment. The subject may be a mammal or vertebrate or other animal or insect, or fish. The method may find particular application in treating the eyes and skin of a mammal or vertebrate. The laser system may be a solid-state laser system.

In a twelfth aspect there is provided a laser system according to the above aspects and/or arrangements when used for treating, detecting or diagnosing a selected area requiring such diagnosis or treatment on or in a subject. The laser system may be a solid-state laser system.

### BRIEF DESCRIPTION OF THE DRAWINGS

Arrangements of the laser system will now be described by way of example with reference to the accompanying drawings wherein:

FIG. 1 is a diagrammatic illustration of an example laser system;

FIG. 2 is a diagram illustrating 1.06/1.3 μm switching using a shutter;

FIG. 3 is a diagram illustrating triple cavity switching;

FIG. 4 is a diagram illustrating tuning one cavity with an etalon;

FIG. 5 is a diagram illustrating simultaneous output using a translatable shutter;

FIG. 5A is a graph showing the approximate fractions of output for two different wavelengths as a shutter is translated in the arrangement of FIG. 5;

FIG. 6 is a diagram illustrating simultaneous output using a circular aperture;

FIG. 7 is a diagram illustrating simultaneous output using a small mirror;

FIG. 8 is a diagram illustrating switchable output between each output wavelengths and between simultaneous output;

FIG. 9 is a diagram illustrating simultaneous operation and sum frequency mixing;

FIG. 10 is a diagrammatic illustration of a laser system comprising multiple reflectors and multiple shutters; and

FIG. 11 shows a diagrammatic representation of the laser system of Example 1;

FIG. 12 shows the output energy at each wavelength from Example 1;

FIG. 13 shows the outputs from the system of Example 1 with the shutter either open or closed;

FIG. 14 shows a diagrammatic representation of the laser used in Example 2

FIG. 15 shows the output characteristics of the laser system of Example 2;

FIG. 16 shows a temporal trace of a sub pulse from Example 2;

FIG. 17 shows a diagrammatic representation of the laser used in Example 3;

FIG. 18 shows different pairs of reflectors that may be used in to obtain spatially separated wavelengths of laser light; and

FIGS. 19A to 19F show examples of an end view of small reflector arrangements having different cross-sections with respect to laser materials of various cross-sections.

### DETAILED DESCRIPTION

In arrangements of the laser systems disclosed herein, a laser beam is generated by a laser material. The laser material may be capable of emitting, in use, a laser beam, when pumped by pump radiation, said laser beam having at least two different wavelengths. The pump radiation may be generated by supplying current to a diode pump laser, such that a portion of the power of the pump radiation is absorbed by the laser material, or may be generated by a flashlamp pump source or some other suitable pump source. There may be one or more collimating lenses and one or more focusing lenses, for collimating and/or focusing the pump radiation. The system may be fitted with a selector (a shutter, an adjustable aperture or moving mirror) for selecting a desired wavelength of laser light for output. The outputting may by means of an output reflector or of a separate output coupler. The output reflector may be an output coupler, for decoupling and outputting an output beam from the cavity.

It will be understood by one skilled in the art that the frequency and wavelength of a laser beam are connected by the equation:

Speed of light=wavelength*frequency

As a consequence, when reference is made to frequency shifting, frequency converting, different frequencies, and similar terms, these are interchangeable with the corresponding terms wavelength shifting, wavelength converting, different wavelengths, and the converse is also true (i.e. where “wavelength” terms are used, the corresponding “frequency” terms may be used.

In the case of a laser material exhibiting multiple competing transitions, such as Nd:YAG, the emission cross-section of each transition provides an indication as to which transition is likely to dominate. Other factors such as the resonator loss may be set (by tailoring mirror transmission characteristics) to alter the effective gain, ie., the net gain upon passage of the laser light upon one complete round-trip through the resonator, of the transitions generated by the laser material for a specific design. In this case the resonator may be designed such that a lower gain transition can exhibit higher effective gain than a usually higher gain transition. In this case the lower gain transition can be made to dominate. As the intrinsic gain of each transition in the gain medium is a material property that can not be altered, some arrangements use resonator design to change the effective gain characteristics of each transition, such that the chosen transition will dominate.

The laser arrangements of the laser systems disclosed herein may be a diode-pumped laser system, a flashlamp-pumped system or may use some other type of pumping. It may be a solid-state laser system.

In arrangements of the laser systems disclosed herein, there may be a plurality of different wavelengths of laser light resonating. The laser system may also have a non-linear medium capable of frequency doubling or sum frequency generation.

The pump radiation may be provided from a diode laser, a fibre coupled diode laser or it may be from an arclamp or flashlamp, or from some other pump source. The pumping may be end pumping or side pumping. The power of the output laser beam from the laser system may be dependent on the duty cycle of the pump radiation, and the system may have means (such as a modulator) for altering the frequency and duty cycle of the pump radiation in order to alter the power of the output laser beam.

In constructing arrangements of the laser systems disclosed herein, it is important that components of the laser are correctly positioned in order to achieve acceptable conversion efficiency to output laser power.

The materials used for the laser material and the non-linear medium (if present) are well known in the art. Commonly neodymium is used as the dopant (i.e. the active ion) in the laser material, and suitable laser media include Nd:YLF, Nd:YAG, Nd:YALO, Nd:GdVO₄ and Nd:YVO₄, although other dopant metals may be used. Other dopant metals (active ions) that may be used include ytterbium, erbium, chromium and thulium, and other host materials that may be used include YAB, YCOB, KGW and KYW. Further solid state laser systems may also be used for example alexandrite. Each of the laser media produces a characteristic output frequencies. The laser system may be a solid state laser system, a fibre laser system, gas laser system, liquid laser system (such as a dye laser system) and/or Raman laser system, i.e. the laser medium may be a solid, a liquid (e.g. comprising a dye), a gas or a fibre. The laser may comprise a Raman-active medium e.g. a Raman-active crystal. Suitable Raman-active media include KGW (potassium gadolinium tungstate), KYW (potassium yttrium tungstate) barium nitrate, lithium iodate, barium tungstate, lead tungstate calcium tungstate, gadolinium vanadate and yttrium vanadate.

Examples of nonlinear materials which may be used in the arrangements of the laser systems disclosed herein for frequency doubling or sum frequency generation include crystalline LBO, BBO, BiBO, KTP, CLBO or periodically poled materials such as lithium niobate, KTP, KTA, RTA or other suitable materials. Periodically poled materials may generate frequency doubled or summed frequency outputs through quasi-phase matching. Frequency doubling is most efficient when “phase-matching” is achieved between a wavelength and its second harmonic. A way to configure a non-linear crystal relates to the way the crystal is “cut” relative to its “crystal axes”. These crystal axes are a fundamental property of the type of crystal. The crystal may be manufactured with a “cut” to best provide phase-matching between a selected wavelength and its second harmonic. Fine tuning of this phase-matching may be achieved by “angle-tuning” the medium. The angle tolerance may be less than 0.1 degree, and temperature may be maintained within 0.1 degree. These tolerances vary depending on the nature of the crystal. Alternatively the fine tuning may be achieved by temperature tuning the medium. For wavelength switching, a nonlinear material is preferred that provides phase-matching between the selected output wavelengths for a small change in temperature (e.g. between about 25 Celsius degrees and about 150 Celsius degrees). The nonlinear material may provide phase-matching between the selected output wavelengths for a change in temperature of between about 25 and 100, 25 and 50, 25 and 40, 25 and 30, 50 and 150, 100 and 150, 120 and 150, 140 and 150, 140 and 150, 30 and 120, 50 and 100, 30 and 70, 50 and 80 or 40 and 50° C., e.g. about 25, 30, 35, 40, 45, 50, 55, 60, 65, 70, 75, 80, 85, 90, 95, 100, 110, 120, 130, 140 or 150 Celsius degrees. Phase matching may be achieved by a change in temperature of less than about 25 Celsius degrees, e.g. about 20, 15, 10 or 5 Celsius degrees

It is important for the efficient operation of the laser system described herein that the component parts of the system be located correctly. In particular, the non-linear medium should be located at a position where the diameter of the beam to be wavelength converted is sufficiently small to achieve acceptable conversion efficiency.

Due to thermal lensing in addition to curvature of the reflectors and natural diffraction, the beam width of a laser beam within the resonator cavity of the arrangements of the laser systems may vary longitudinally through the system as a result of heating effects. Since the efficiency of the processes occurring in a non-linear medium increases with an increase of the power of the incident laser beam, the location of the non-linear medium in arrangements of the laser systems disclosed herein it is critical to the efficient operation of the system. Furthermore, since the heating of components of the system is due to passage of a laser beam through those elements, the optimum location of the elements will vary both with time during warm-up of the system and with the power of the laser system.

The thermal lens in the laser material impact substantially on the stability characteristics of the resonator in a dynamic way. Suitably the position of the laser material and/or reflector (mirror) curvatures is such that the laser is capable of stable operation.

Suitably a curvature of at least one of the reflectors and/or the positions of the laser material are such that the focal lengths of the laser material at pump input powers is maintained within a stable and preferably efficient operating region. In some arrangements this may be achieved by optimising the system configuration as a function of the focal lengths by in addition to positioning the laser material within the system and/or selecting a curvature of at least one of the reflectors, optimising one of more of:

a separation between one or more of the reflectors and the laser material;

transmission characteristics of the output coupler; and

the pulse repetition frequency (if the laser system is pulsed).

In some arrangements the laser system is also optimised for given pump powers for optimum mode sizes in the laser material and if present a non-linear medium and optimum laser output power so as to obtain efficient energy extraction from the laser material whilst maintaining operating stability and avoiding optical damage of the laser components i.e., the various components are matched on the basis of their associated mode sizes. The system is suitably optimised so that the relative mode size in the laser material is such so as to provide efficient stable output. In order for the laser system to operate with suitable optimal efficiency the key design parameters (i.e. mirror curvatures, cavity length, positioning of the various components) are suitably chosen so that the resonator mode sizes in the laser material (A), and if present the non-linear medium (frequency-doubling crystal) (B) are near-optimum at a desired operating point. One can denote the beam sizes (radii) in these media as ω_{A} and ω_{B} respectively. In cases where the laser beam is not circular, it is commonly elliptical, and the beam size may be considered along the long and short axes of the ellipse. The beam size is taken to be the distance from the beam axis to the point where the intensity of the beam falls to 1/(e²) of the intensity of the beam axis. The beam size may vary along the length of a particular component. The beam size in a particular component may be taken as the average beam size within the component or as the minimum beam size within that component. ω_{A} is suitably mode-matched to the dimension of the pumped region of the laser material i.e., the pump spot size (ω_{P}). ω_{P} can vary according to the power of the pump laser source (e.g., a diode laser) and the pumping configuration.

In some arrangements the thermal lens focal length for the laser material at the laser input powers is determined and the position of the laser material in the cavity are selected to ensure that during operation of the laser the resonator is stable. Suitably the thermal lenses for the laser material can be calculated and then confirmed by cavity stability measurement. Alternatively the thermal lenses can be determined by standard measurement techniques such as lateral shearing interferometry measurements which can also provide information on any aberrations. A suitable interferometric technique is described in M. Revermann, H. M. Pask, J. L. Blows, T. Omatsu “Thermal lensing measurements in an intracavity LiIO3 Laser”, ASSL Conference Proceedings February 2000; in J. L. Blows, J. M. Dawes and T. Omatsu, “Thermal lensing measurement in line-focus end-pumped neodymium yttrium aluminium garnet using holographic lateral shearing interferometry”, J. Applied Physics, Vol. 83, No. 6, March 1998; and in H. M Pask, J. L. Blows, J. A. Piper, M. Revermann, T. Omatsu, “Thermal lensing in a barium nitrate Raman laser”, ASSL Conference Proceedings February 2001.

The laser material can be pumped/stimulated by a pulsed or continuous arclamp, flashlamp diode (semiconductor) laser using a side-pumped, single end-pumped or double end-pumped geometry or any other laser (in the case of Raman laser). Compared to side-pumped laser crystals, end-pumped laser crystals generally have high gain and give rise to short Q-switched pulses. The pump spot size in the laser crystal can be adjusted to match the resonator mode size. However end-pumped laser crystals can also give rise to strong (and abberated) thermal lensing, and this ultimately limits the scalability of end-pumped lasers.

Side-pumping of the laser crystal may not result in high optical-optical conversion efficiency, but it is a cheaper approach, is more easily scalable and enables greater flexibility in where the resonator components can be placed.

The laser beam may be Q-switched. The power of the laser beam at each element of the laser system should however be below the damage threshold of that element. Thus the energy of the laser beam in the laser material should be below the damage threshold for that particular laser material and the energy of the laser beam in the non-linear medium (if present) should be below the damage threshold for that particular non-linear medium. The damage threshold of a particular element will depend, inter alia, on the nature of that element. The peak power of a laser pulse generated by a Q-switch may be calculated by dividing the energy by the pulse width. Thus for example if the laser pulse energy is 200 μJ and the pulse width of the Q-switched laser beam is 10 ns, then the laser power will be 200 μJ/10 ns, ie 20 kW. The power density of the laser beam at any particular location may be calculated by dividing the power of the laser beam at that location by the mode size (area) at that location. The power density of the laser beam at each element of the system maybe below the damage threshold for that particular element, that is the power densities for the laser material and, if present, the non-linear medium, should be below their respective damage thresholds. Thus for example for an LBO crystal with a 1 GWcm-2 damage threshold, the above Q-switched laser beam with 20 kW peak power should have a mode radius size of greater than 25 μm. This will be the minimum mode size that may be used without damage to that element. Since the repetition rate of the Q-switch affects the power deposition in the elements of the laser system, it will affect the heating and hence the thermal lensing of those elements. Thus, if the laser is Q-switched, the repetition rate should be chosen such that the system is stable and so that the damage thresholds of the elements are not exceeded. The repetition rate may be between about 1 Hz and about 500 kHz, and may be between about 1 Hz and 10 kHz or about 1 Hz and 1 kHz or about 1 and 100 Hz or about 1 and 10 Hz or about 100 Hz and 50 kHz or about 1 and 50 kHz or about 10 and 50 kHz or about 20 and 50 kHz or about 1 and 15 kHz or about 15 and 50 kHz or about 10 and 30 kHz or about 5 and 10 kHz or about 5 and 15 kHz or about 5 and 20 kHz or about 5 and 25 kHz or about 7.5 and 10 kHz or about 7.5 and 15 kHz or about 7.5 and 20 kHz or about 7.5 and 25 kHz or about 7.5 and 30 kHz or about 10 and 15 kHz or about 10 and 20 kHz or about 10 and 25 kHz, or about 1 and 500 kHz, 10 and 500, 1 and 250, 1 and 100, 1 and 50, 10 and 250, 10 and 100, 10 and 50, 50 and 500, 100 and 500, 200 and 500, 300 and 500, 400 and 500, 50 and 250, 50 and 100 or 100 and 200 kHz, and may be about 1, 5, 10, 20, 30, 40, 50, 100, 200, 300, 400, 500, 600, 700, 800 or 900 Hz or about 1, 2, 3, 4, 5, 6, 7, 8, 9, 10, 15, 20, 25, 30, 35, 40, 45, 50, 60, 70, 80, 90, 100, 150, 200, 250, 300, 350, 400, 450 or 500 kHz. The pulse duration of the Q-switched laser beam may be in the range of about 1 to about 250 ns, or about 1 to 100 ns, or about 1 to 50 ns, or about 1 to 20 ns or about 1 to 10 ns or about 5 to 80 ns or about 5 to 75 ns or about 10 to 50 ns or about 10 to 75 ns or about 20 to 75 ns or about 5 to 100 ns or about 10 to 100 ns or about 20 to 100 ns or about 50 to 100 ns or about 5 to 50 ns or about 10 to 50 ns, or about 100 to 250 ns, 200 to 250 ns, 50 to 250 ns, 50 to 150 ns or 100 to 150 ns and may be about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 150, 150, 160, 170, 180, 190, 200, 210, 220, 230, 240 or 250 ns. The resonator cavity may have a folded or linear configuration or other suitable configuration. The laser material suitably generates a laser beam at least two wavelengths (1.06 and 1.3 microns for Nd:YAG) when stimulated by pump light of an appropriate wavelength, and the fundamental laser beam then propagates inside the laser resonator. Suitably the laser material is formed by one of the following crystals: Nd:YAG, Nd:YLF, Nd:glass, Ti-sapphire, Erbium:glass, Ruby, Erbium:YAG, Erbium:YAB, Nd:YAlO3, Yb:YAlO3, Nd:SFAP, Yb:YAG, Yb:YAB, Cobalt:MgF2, Yb:YVO4, Nd:YAB, Nd:YVO4, Nd:YALO, Yb:YLF, Nd:YCOB, Nd:GdCOB, Yb:YCOB, Yb:GdCOB or other suitable laser material. The laser material may be broadband AR-coated for the 1-1.35 micron region to mninimise resonator losses. Optionally the laser material, is wavelength tunable and capable of generating high power output which can be mode-locked. The laser material may be an optical fibre.

Optionally a solid non-linear medium is used for frequency doubling the laser beam to produce an output at its second harmonic or other sum frequency or different frequency wavelength. The solid non-linear medium can be located in the cavity (intra cavity doubled—doubling crystal located inside the resonator) or external to the cavity (extra cavity doubled—doubling crystal located outside of the laser resonator). A folded resonator may be used. Suitable solid non-linear mediums include a second harmonic generator (SHG), a sum frequency generator (SFG) or a difference frequency generator (DFG). As examples of non-linear medium mention can be made of LBO, KTP, BBO, LiIO3, KDP, KD*P, KBO, KTA, ADP, LN (lithium niobate) or periodically-poled LN or combinations thereof (e.g. to generate green, red and yellow lasers simultaneously). Suitably a LBO, BBO or KTP crystal is used. The light can be frequency doubled or frequency summed by angle-tuning and/or controlling the temperature of the solid non-linear medium. In some arrangements the light is frequency summed so as to generate yellow light. Typical variations in the visible wavelength with a LBO crystal cut for type 1 non-critical phase-matching with temperature tuning to approximately 149° C., 40° C. or 0° C. include 532 nm (green), 578-593 nm (yellow) and 660-670 nm (red). By such frequency doubling it may possible to generate wavelengths in the yellow or orange spectral region suitable for dermatological, ophthalmic and visual display applications. The resonator design may be such that the size of the laser beam in the doubling medium is sufficiently small to allow efficient conversion and high output powers but large enough to avoid optical damage. Suitably the solid non-linear medium is AR-coated to minimise losses in the 1-1.35 micron region and in the visible where possible. A suitable AR coated LBO crystal for intracavity use is 4×4×15 mm and for extracavity use is 4×4×15 mm although other sizes can be used.

The arrangements of the laser systems disclosed herein comprises at least three reflectors, which can be mirrors. Other suitable reflectors that can be used include prisms or gratings. Reflectors can be provided with special dielectric coating for any desired frequency. The mirrors can provide for the laser output to be coupled out of the system such as by use of a broadband dichroic mirror transmissive at the frequency of the output beam but suitably highly reflective at other frequencies so as to cause build-up of the power intensities of the beams in the system. Alternatively a polarisation beam splitter can be used to outcouple the laser output. Suitably the mirrors are chosen so as to be greater than 99% reflective at the desired wavelengths. The laser resonator is suitably a stable resonator which supports the TEM₀₀ mode and/or higher order spatial (transverse) modes. The frequency-doubled or frequency summed laser beam, if generated, may be coupled out of the resonator through a dichroic mirror—i.e. a mirror which has high transmission at the frequency-doubled wavelength but high reflectivity at the fundamental wavelength.

Suitably the transmission characteristics, radius of curvatures and separation of the reflectors are tailored to achieve efficient and stable operation of the laser system, and when a solid non-linear medium is used, to generate output at the visible wavelengths by frequency doubling or sum frequency generation in the non-linear medium. Suitably the curvature of the reflectors and cavity length are optimised to obtain the desired mode diameter such that near-optimum beam sizes are achieved such that changes in the focal length of the laser material as a result of thermal effects in the laser material during operation of the laser do not cause the laser modes to expand to the extent that the radiation suffers large losses. The laser material and, when present, the non-linear medium can be positioned in the system as discrete elements. Alternatively one or more of the components can be non-discrete, one component performing the dual function of both the laser material and the non-linear medium (such as self-frequency doubling or self doubling materials such as Yb:YAB and Nd:YCOB).

Where reference is made in the specification to reflective or transmissive reflectors, these may be highly reflective or highly transmissive respectively. High reflectivity or transmissivity may be taken as greater than about 80% reflectivity or transinissivity respectively, or greater than about 85, 90, 95, 96, 97, 98 or 99%, for example about 85, 90, 95, 96, 97, 98, 99, 99.5, 99.6, 99.7, 99.8 or 99.9%. Where reference is made to low transmissivity or low reflectivity, this may refer to transmissivity or reflectivity (respectively) of less than about 20%, or less than about 10, 5, 2, 1, 0-0.5, 0.2 or 0.1%, for example about 10, 9, 8, 7, 6, 5, 4, 3, 2, 1, 0.9, 0.8, 07, 0.6, 0.5, 0.4, 0.3, 0.2, 0.1, 0.05 or 0.01%. It will be understood that reference to reflection in this specification is to specular reflection. Specular reflection from reflectors is required to enable resonance of a laser beam in a cavity. Diffuse reflectance or scattering is not included in the scope of reflectance in the context of this specification, as it will not support resonance in a laser cavity.

The pulse repetition frequency of the output may if desired be varied by modulating the pump radiation or using a Q-switch such as an active Q-switch or a passive Q-switch. An acousto-optic Q-switch, an electro-optic Q-switch or passive Q-switches (Cr:YAG) can be used. Alternatively a cavity dumping configuration or other suitable means can be adopted (see “The Laser Guidebook” by Jeff Hecht, 2^{nd} Edition, McGraw-Hill 1992, the whole content of which is incorporated by cross reference). The Q-switch causes laser output to occur in a pulsed format with high peak powers. The Q-switch may be broadband AR-coated for the 1-1.35 micron region to minimise resonator losses. The selection and alignment of the Q-switch is tailored to achieve a high-Q resonator for the fundamental. The pulse frequency is suitably chosen to provide system stability.

The Q-switch may be any of the following types: acousto-optic, electro-optic or passive.

The arrangements of the laser systems disclosed herein overcome the limitations of the prior art by using fixed optics in combination with a shutter located in the system. In the case where the present arrangements involves two or more wavelengths resonating simultaneously, the wavelengths are spatially separated, which avoids the complicated dynamics of gain-balanced systems. Spatial separation in a single crystal has been achieved before (I. S. Moskalev, V. V. Federov, and S. B. Mirov, “Multiwavelength mid-IR spatially-dispersive CW laser based on polycrystalline Cr2+:ZnSe” Optics Express 12, 4986-4992 (2004)), but the authors in that case utilised two totally separate pump modes. This is fundamentally different to the present arrangements of laser systems.

The shutter used in some arrangements of the laser systems disclosed herein may be made of any convenient material. It may comprise material with low reflectivity. It may comprise a material that absorbs laser light or disperses laser light or diffusely reflects or scatters laser light. (Reference to low reflectivity encompasses materials that reflect diffusely so that they can not act as a reflector within a laser cavity). It should be understood that when reference is made to the shutter, this refers not only to the light-blocking portion of the shutter but to an aperture revealed by the shutter. Thus when the shutter is open, laser light can pass through the aperture, as the light-blocking portion of the shutter does not block passage of the laser light. As described below in some of the arrangements of the laser system, the shutter may also refer to non-opaque shutter element, which may be a transparent or partially transparent material. The non-opaque shutter element may further be a refractive material. For example, in some arrangements, the shutter may be a prism. In other arrangements, the shutter may also be a combination elements comprised of one or more components. For example, the composite shutter may comprise a Q-switch module (i.e. either an acousto-optic or an electro-optic Q-switch) and an optical rotator, which may act to rotate the polarisation of any linear polarised laser beams in the laser system.

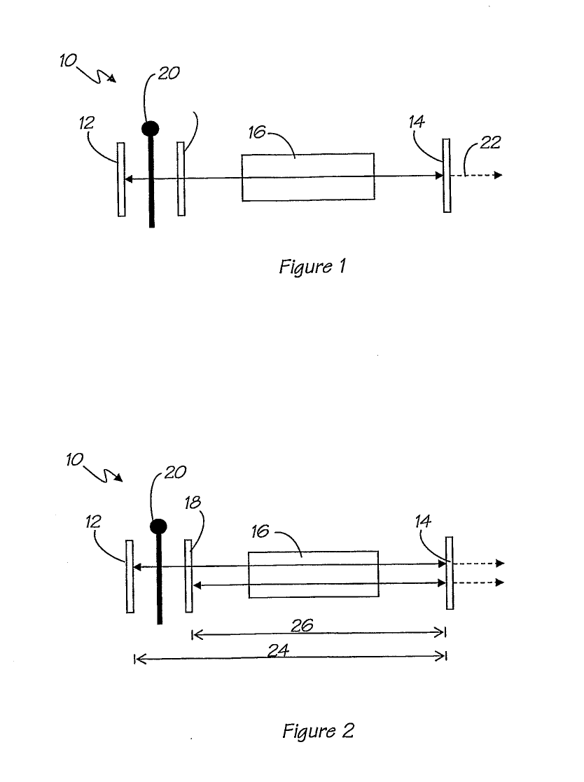

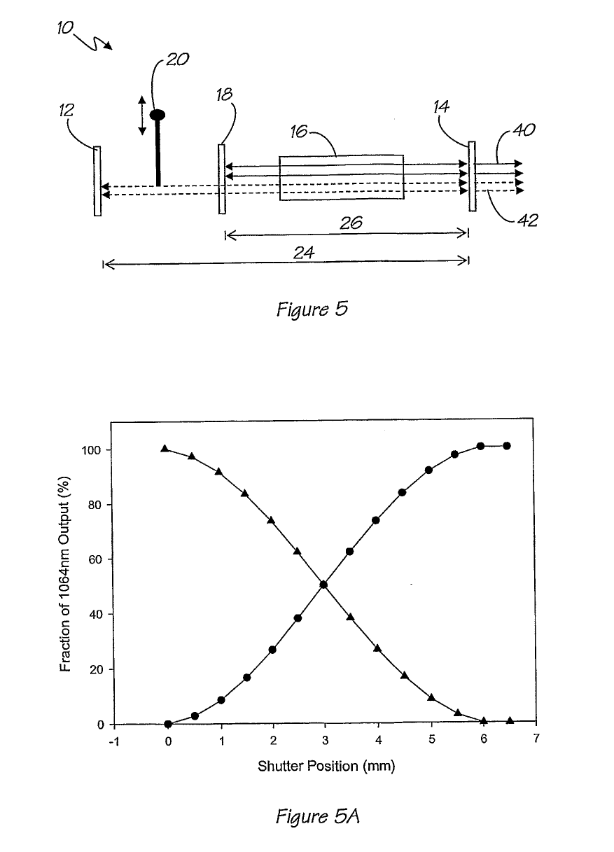

In some arrangements, the laser system contains several key components:
(1) a simple mechanical shutter allows switching between 1.06 μm and 1.3 μm transitions of Nd:YAG as shown in FIGS. 1 and 2. Thus laser system 10 comprises first reflector 12 and second reflector 14. Laser material 16 (Nd:YAG) is disposed between reflectors 12 and 14, and is capable of generating at least two different wavelengths of laser light when pumped by pump radiation. Third reflector 18 is disposed between reflector 12 and laser material 16, and is transmissive towards that wavelength of laser light generated by the laser material with highest gain and reflective towards another of the wavelengths of laser light. Shutter 20 is disposed between reflector 12 and reflector 18 so as to prevent laser light generated by laser material 16 from passing to reflector 12 when shut, and to permit laser light generated by laser material 16 to pass to reflector 12 to reflector 12 when open.
Laser system 10 is configured to normally operate at 1.3 μm with shutter 20 closed. Opening mechanical shutter 20 allows feedback from high reflector 12, so that the laser output is dominated by the higher gain 1.06 μm transition. Outlined herein are examples and arrangements of the procedure needed to select the reflectivities of the output coupler (reflector 14) and high reflectors 12 and 18 so that system 10 switches the gain-loss equation in favour of the respective transitions. The examples and arrangements described may be equally applicable to laser systems having other transitions, and other combinations of laser ion and host materials with their respective transitions. The system may operate under conditions under which there is gain competition between two wavelengths generated by the laser material.
(2) a simple means for producing simultaneous 1.06 μm and 1.3 μm operation of Nd:YAG and the ability to control the proportion of energy in each wavelength. This arrangement is an extension of (1), except that shutter 20 may be partially opened so that different parts of laser material 16 receive feedback at different wavelengths, so both wavelengths can resonate simultaneously as shown in the arrangement of FIG. 5. The respective proportions of the two wavelengths may be varied by translating shutter 20 across the beam axis 22 (shown in FIG. 1 but not indicated in FIG. 2).
Alternatively the laser system may utilise an aperture to obtain a circular cross section designed to operate on one transition, which is different to the rest of the gain medium. Instead of an aperture, the system may also use composite mirrors consisting of for example, a “spot” mirror of diameter less than the gain medium cross section, in front of a larger high reflector providing high reflection at the second wavelength. The composite mirror could be segmented in many ways (eg. semi-circular, quadrants etc.) depending on the demands of the application. This composite mirror may also be segmented in halves, such that lateral translation across the beam axis can alter the proportion of two or more wavelengths from the system. It may also be an advantage to use reflectors that have a gradient in reflectivity or have zone diminished reflectivity. By way of example, the approximate fractions of 1.06 μm and 1.3 μm output as a shutter is translated from the position removed from the axis and not interacting with the intracavity beams (shutter position=−1 mm), to a position at that prevents radiation from passing to the end mirror 12 (shutter position=7 mm) are shown in FIG. 5A.
(3) a simple means for operating 1.06 μm and 1.3 μm transitions of Nd:YAG simultaneously and consequent sum frequency generation to produce high energy yellow radiation at 589 nm. This is a simple extension of 2) above, where both transitions operate spatially separated in a high Q cavity, which enables efficient frequency conversion to the yellow.
The inventors have also observed that in a system as described in FIG. 1 in which the shutter is open and the third reflector is slightly misaligned, it is in certain circumstances possible to output both the first and third wavelengths simultaneously. It is thought that the wavelengths may be slightly separated spatially in this case. If a sum frequency generator is inserted into such a cavity, it may be possible to output the summed frequency. Thus for example yellow may be obtained from an LBO laser crystal. It is clear that in this case, the shutter, being open, serves no function, and may be omitted.

All of the above features may also be applied to other laser materials and their respective transitions. The above features are also applicable to q-switched or non-q-switched lasers, and modelocked lasers. The above features are applicable to flashlamp, or diode-pumped solid-state lasers, electrical discharge gas lasers, diode lasers and other types of lasers.

Thus the arrangements of the laser system are capable of providing wavelength switching using a shutter and no moving optics. By contrast, the only means described in the prior art for switching between laser transitions use complex techniques, which usually involve the movement of alignment sensitive components. This is a disadvantage in a commercial product. The present system allows switching using a mechanical shutter that does not affect the optical alignment of the system. Benefits of the present system include greatly improved reliability of the laser system and very fast switching speeds. Shutters are available with switching speeds typically about 1 ms. High switching speeds may be achieved using more advanced shutters such as rotating choppers, Pockels cells and frustrated internal reflection arrangements. The switching speed may be less than about 100 ms, or less than about 50, 20, 10, 5, 2, 1, 0.5, 0.2 or 0.1 ms. It may be between about 0.1 and about 100 ms, or between about 1 and 100, 10 and 100, 50 and 100, 0.1 and 10, 0.1 and 5, 0.1 and 1, 1 and 100, 1 and 10, 1 and 5 or 0.5 and 5 ms, and may be about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 25, 30, 35, 40, 45, 50, 60, 70, 80, 90 or 100 ms. Even higher switching speeds may be available, for example between about 10 and 1000 ns, or between about 50 and 1000, 100 and 1000, 250 and 1000, 10 and 500, 10 and 100 or 10 and 50 ns, e.g. about 10, 20, 30, 40, 50, 60, 70, 80, 90, 100, 150, 200, 350, 300, 350, 400, 450, 500, 550, 600, 650, 700, 750, 800, 850, 900, 950 or 1000 ns.

The present arrangements of the laser system are also capable of providing simultaneous wavelength generation by spatial separation in the gain medium. The wavelengths generated may be different wavelengths depending on the nature of the gain medium. For example the gain medium may have multiple transitions capable of spontaneous emission to generate the different wavelengths such as seen with a neodymium (Nd) active ion in the gain medium. In other arrangements the gain medium may have a broadband spontaneous emission bandwidth capable of producing the different wavelengths for example those systems having an active ion with a broad emission bandwidth such as ytterbium, erbium, thulium, or chromium, or it may be some other material with a broad emission bandwidth such as alexandrite. There are several techniques described in the prior art for obtaining multiple transitions simultaneously from laser materials such as Nd:YAG and Nd:YAP. These methods commonly require multiple laser heads, which makes intracavity non-linear frequency conversion impossible and also effectively eliminates the cost advantages of a single laser head. Other systems use complex dual-cavity gain-loss balancing, which is commonly unreliable, especially for materials such as Nd:YAG in which the two transitions originate from the same energy level. The present system uses spatial separation of the two transitions within a gain medium consisting of a single laser rod or pumped volume, which is hitherto unknown.

In the present arrangements of the laser system, the two transitions are configured to operate (resonate) within two distinct resonator cavities which each access spatially separated regions of the gain material i.e. the laser system is a multispatial laser system with at least two distinct spatial (transverse) modes, and each of the two transitions are configured to operate in a distinct spatial mode. In this configuration, the two resonator cavities access non-identical spatially separated regions of the gain material i.e. the two laser transitions access distinct, non-identical gain volumes of the laser material so that each has sufficient gain to overcome the loss in the respective resonator configured for operation on that transition, thereby generating laser beams at the wavelengths of the two transitions simultaneously. (It will be appreciated that, whilst the non-identical gain volumes accessed by the two resonator cavities are described as being spatially separated, there may be some overlap between the optical field in each of the resonator cavities, for example due to the nature of the transverse mode distribution.)

Spatial separation provides two important features of operation:

### a) Continuously Variable Ratio of Output at the Two Wavelengths

In systems described in the prior art, the ratio of output at the two wavelengths can only be changed by changing the optics, the alignment of optics or the pump power level. In the present system, the ratio of output wavelengths may be continuously varied by adjusting the position of a shutter. This provides a low-cost, robust and fast method to adjust the spectral content of the output laser beam which does not require the pump power to be adjusted or optics to be realigned (i.e. as depicted in FIG. 5A).

### b) Efficient Sum Frequency Generation (SFG)

Sum frequency generation of the two Nd:YAG transitions to produce yellow radiation has been extensively investigated for sodium guide star lasers. However, these systems require far different output characteristics and as such, they utilise complex and expensive technological advancements that do not translate well to high energy medical laser requirements. Mixing of the two transitions has been described in the prior art using dual cavity arrangements, but the complex gain balancing techniques required is difficult to sustain for all but only carefully selected operating conditions. The present system, which allows spatial separation of the two transitions (i.e. wavelengths) and allows the ratio of the wavelengths to be continuously adjusted, provides a means for efficiently generating sum frequency output over a wide range of operating conditions for a fixed set of optics.

The present system is useful for SFG by intracavity or extracavity conversion. For the latter, the laser is often Q-switched.

Representative arrangements of the laser systems are described below with reference to a Nd:YAG laser system operating on one or both of the 1.06 μm and 1.3 μm transitions. It will be appreciated that the techniques and systems described below are equally applicable mutandis mutatis to alternate laser systems with two (or more) radiative transitions or even a broadband laser source operating on two or more wavelengths within the emission bandwidth of the active ion (e.g. ytterbium, erbium, chromium, alexandrite etc).

### 1.06/1.3 μm Switching

As previously outlined, this technique relies on first and second resonator cavities 24 and 26 respectively as indicated in FIG. 2. With reference to FIG. 2, the 1.06 μm resonator mirrors 12 and 14, which define cavity 24, are configured so that cavity 24 exhibits the lowest threshold, producing efficient 1.06 μm output through output coupling mirror 14. When shutter 20 is closed, 1.3 μm cavity 26, defined by reflectors 14 and 18 then exhibits the lowest threshold. Again efficient 1.3 μm output exits cavity 26 through output coupling mirror 14 as shown in FIG. 2. Accordingly, with shutter 20 closed the gain of resonator 26 exhibits higher gain for the 1.3 μm than 1.06 μm due to increased transmission of the 1.06 μm radiation.

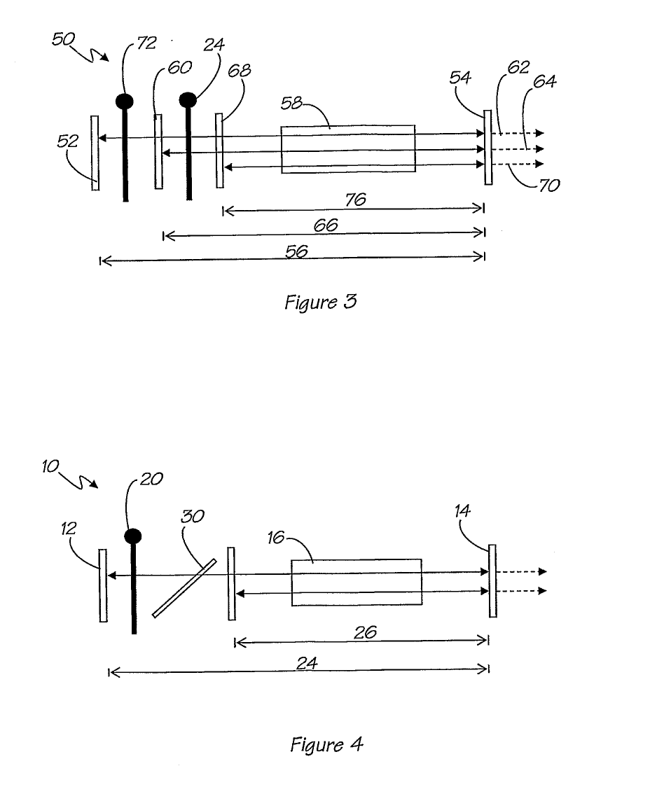

As an extension of the above resonator, the same principle could be applied to three sets of transitions using an additional mirror and shutter as shown in FIG. 3. In theory this could be extended many times (but in practice this might be difficult).

With reference to FIG. 3, laser system 50 comprises first reflector 52 and second reflector 54, which define a first resonator cavity 56. Laser material 58 is disposed between reflectors 52 and 54, and is capable of generating at least three different wavelengths of laser light when pumped by pump radiation. A third reflector 60 is disposed between the reflector 52 and laser material 58, and is transmissive towards that wavelength of laser light generated by the laser material with highest gain (shown as beam 62) and reflective towards a second wavelength of laser light (shown as beam 64) generated by the laser material. Reflectors 54 and 60 define a second resonator cavity 66. A fourth reflector 68 is disposed between reflector 60 and laser material 58, and is transmissive towards that wavelength of laser light generated by the laser material with highest gain (beam 62), transmissive towards the second wavelength of laser light (beam 64) and reflective towards a third wavelength of laser light (beam 70) generated by laser material 58. Beam 70 is generated by laser material 58 at lower gain than beams 62 and 64. A first shutter 72 is disposed between reflectors 52 and 60 so as to prevent laser light generated by laser material 58 from passing to first reflector 52 when shut, and to permit laser light generated by laser material 58 to pass to reflector 52 when open. A second shutter 74 is disposed between reflectors 60 and 68 so as to prevent laser light generated by laser material 58 from passing to reflector 60 when shut, and to permit laser light generated by laser material 58 to pass to reflector 60 when open. Reflectors 54 and 68 define a third resonator cavity 76.

In operation, pump radiation (not shown) is directed to laser material 58 and thereby causes laser material 58 to generate at least three different wavelengths of laser light (represented by beams 62, 64 and 70). When shutters 72 and 74 are both open, beam 62 is capable of resonating in cavity 56, as reflectors 60 and 68 are transmissive to the wavelength of that beam. Beam 62 can then be outputted through reflector 54, acting as an output coupler. When shutter 72 is closed and shutter 74 is open, beam 62 is not capable of resonating, as it is not reflected by reflector 60, and is prevented from reaching reflector 52 by shutter 72. Accordingly, the energy of the wavelength of beam 62 will be transferred to beam 64, which is reflected by reflector 60 and transmitted by reflector 68, and thus beam 64 resonates within system 50 (i.e. within a first resonator cavity 66) and may be outputted through reflector 54, acting as an output coupler. When shutters 72 and 74 are both closed, beam 64 is not capable of resonating, as it is not reflected by reflector 68, and is prevented from reaching reflector 60 by shutter 64. As described above, beam 62 can not resonate due to shutter 72 (and also shutter 74) being closed. Accordingly the energy of beam 64, as well as that of beam 62, will be transferred to beam 70, which is reflected by the reflector 68, and beam 70 will resonate within system 50 (i.e. within a second resonator cavity 76) and may be outputted through reflector 54, acting as an output coupler.

Arrangements of the present system may also comprise a polarisation device, a Q-switches and/or a wavelength selection device. One or more polarisation devices may be inserted to polarise one or both wavelengths depending on the position of insertion. Thus, for example, with reference to FIG. 3, a polarisation device located between reflectors 52 and 60 would polarise only beam 62, a polarisation device located between reflectors 60 and 68 would polarise only beams 62 and 64, and a polarisation device located in cavity 76 would polarise beams 62, 64 and 70. Wavelength selective devices such as birefringent tuners or etalons may be used to tune the outer most cavity section. This is illustrated in FIG. 4, where an etalon 30 has been added to the system shown in FIG. 2 between reflectors 12 and 18 to tune cavity 24.

The principles used in the arrangements of the laser systems disclosed herein are applicable for laser gain media capable of generating more than one wavelength, and particularly in which there is gain competition between the wavelengths (e.g. they share the same upper state laser level and therefore laser oscillation at one wavelength leads to a decrease in gain and available laser energy of the other).

### 1.06/1.3 μm Simultaneous Output

To obtain simultaneous operation of two wavelengths (e.g. 1.06 μm and 1.3 μm, generated by Nd:YAG laser material), the arrangements use spatial separation to operate the two wavelengths in different regions of the gain medium (laser material). This technique effectively allows both wavelengths to oscillate without competition, in a spatially separated, but parallel arrangement. FIG. 5 illustrates how this operates in the laser system shown in FIG. 2. Reflector 14 acts as an output coupler for both wavelengths. Thus, with shutter 20 in a partially closed position as shown in FIG. 5, beam 40 resonates within cavity 26 and beam 42 resonates simultaneously in cavity 24. Beam 42 is spatially (laterally) separated from beam 40, since, in that region of system 10 in which beam 40 is resonating, beam 42 is prevented from resonating due to shutter 20, and in that region of system of system 10 in which beam 42 is resonating, the energy of beam 40 would be diverted into beam 42, which is generated by laser material 16 at higher gain than beam 40. From FIG. 5 it may be seen that the translation of a shutter or beam block across the beam can adjust the proportion of each transition (wavelength) in the laser output.

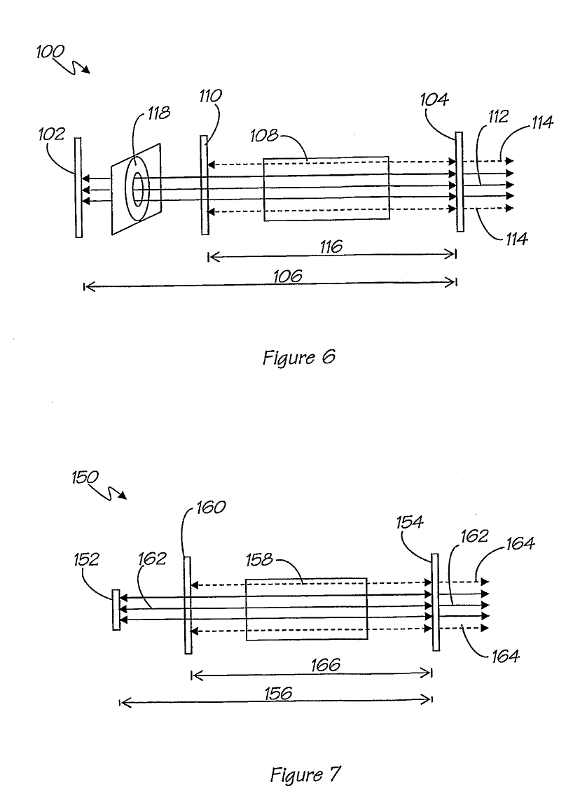

Alternatively the beam block/shutter could be an aperture of any shape, for example a circle, a triangle, a square, a rectangle, a trapezium, a quadrilateral, a pentagon or some other polygon (regular or irregular) having n sides, where n is for example 6, 7, 8, 9, 10, 11, 12, 13, 14, 15, 16, 17, 18, 19 or 20 or more than 20. An example is shown in FIG. 6. In FIG. 6, laser system 100 comprises first reflector 102 and second reflector 104, defining resonator cavity 106. Laser material 108 (e.g. Nd:YAG) is disposed between reflectors 102 and 104, and is capable of generating at least two different wavelengths of laser light when pumped by pump radiation. Third reflector 110 is disposed between reflector 102 and laser material 108, and is transmissive towards the wavelength of beam 112, generated by laser material 108 with highest gain and reflective towards beam 114, having another wavelength of laser light. Reflectors 110 and 104 define resonator cavity 116. Iris 118 is disposed between reflectors 102 and reflector 110. In operation, beam 112, generated by laser material 108, passes through reflector 110 and iris 118, and resonates in cavity 106. In the region of system 100 in which beam 112 resonates, beam 114 can not resonate, since its energy is diverted to beam 112, as it is produced at lower gain that beam 112. However in that region of system 100 in which beam 112 is prevented from resonating by iris 118, beam 114 can resonate, since it is reflected by reflector 110, and therefore resonates within cavity 116.

The means for separating the wavelengths may be adjustable, such as an iris (as shown in FIG. 6), or it may be set. For example it may comprise a dual mirror coating or a mirror smaller than the gain cross section. A further option is represented by a system such as shown in FIG. 6 but omitting iris 118. In this option, reflector 102 may be translated across the beam, such that it only reflects back through a portion of the gain medium, such that two wavelengths will resonate simultaneously in laterally separate portions of the system.

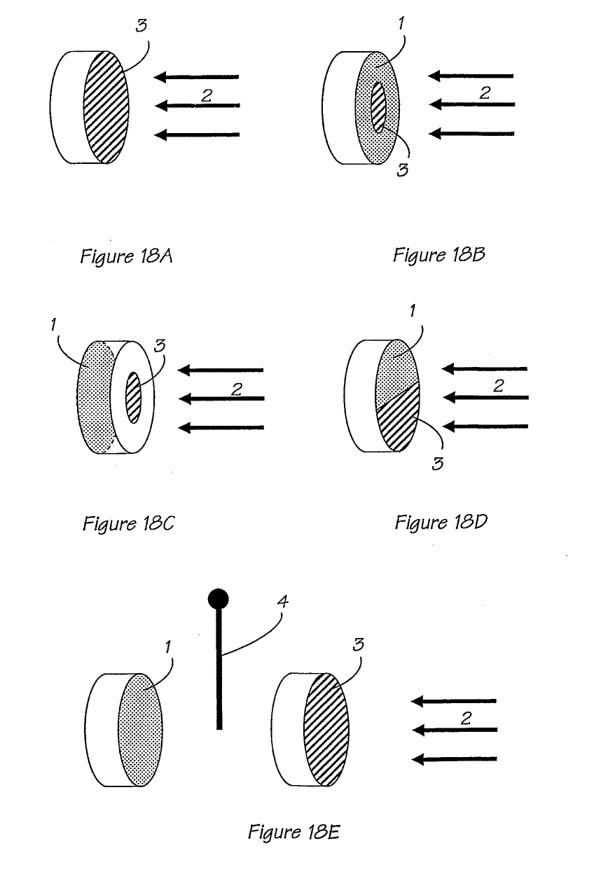

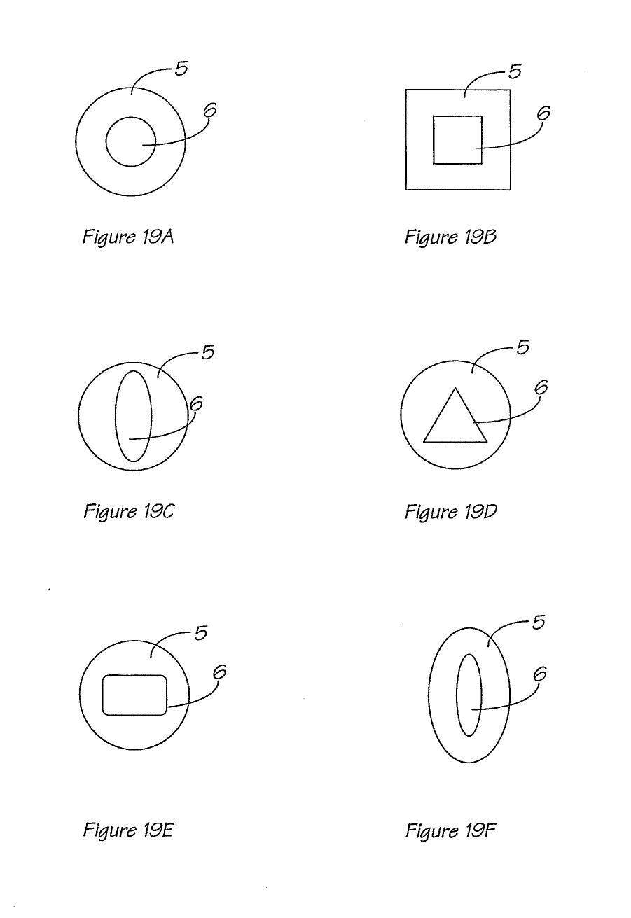

In a further option, illustrated in FIG. 7, a small resonator may be used to provide spatial separation of wavelengths in the system. Thus in FIG. 7, laser system 150 comprises first reflector 152 and second reflector 154, the first reflector 152 being smaller than the second reflector 154, defining resonator cavity 156. Laser material 158 (e.g. a Nd:YAG rod) is disposed between reflectors 152 and 154, and is capable of generating at least two different wavelengths of laser light when pumped by pump radiation. In arrangements of the laser, the laser material rod may be, in cross-section, either circular, square, elliptical, rectangular, triangular, polygonal or other suitable cross-section. The cross-sectional radial extent of reflector 152 (i.e. from the axis of the resonator defined by reflector 152) is less than the cross-sectional radial extent of the laser rod (in cross-section reflector 152 may be circular, square, elliptical, rectangular, triangular, polygonal or other suitable cross-section). In some arrangements, the cross-sectional radial extent may be different in different radial directions although in each radial direction, the radial extent of the reflector is less than the radial extent of the laser material in that direction. (Shown in FIGS. 19A to 19F are example arrangements of the radial cross-section of the laser material 5 compared with that of the small reflector 6.) In other arrangements the small reflector is not located on the axis of the laser resonator. In other arrangements the cross-section of the reflector may be any shape, provided that it does not cover the entire cross-section of the laser material.

Reflector 152 is sufficiently small that it can not reflect all of the laser light generated by laser material 158. Third reflector 160 is disposed between reflector 152 and laser material 158, and is transmissive towards the wavelength of beam 162, generated by laser material 158 with highest gain and reflective towards beam 164, having another wavelength of laser light. Reflectors 160 and 154 define resonator cavity 166. In operation, beam 162, generated by laser material 158, passes through reflector 160, and resonates in cavity 156. In the region of system 150 in which beam 162 resonates, beam 164 can not resonate, since its energy is diverted to beam 162, as it is produced at lower gain that beam 162. However in that region of system 150 in which beam 162 is prevented from resonating due to the small size of reflector 152, beam 164 can resonate, since it is reflected by reflector 160, and therefore resonates within cavity 166.

The aperture or shutter may be made of non-absorbing material (such as a diffuse scatterer or refractive material) to avoid heating or ablating the aperture or shutter. This may be particularly advantageous in high average or high peak power lasers. The shutter may be a mechanical shutter or a non-mechanical, e.g. electronic shutter. It may for example comprise a Pockel cell, electro-optic or an acousto-optic material.

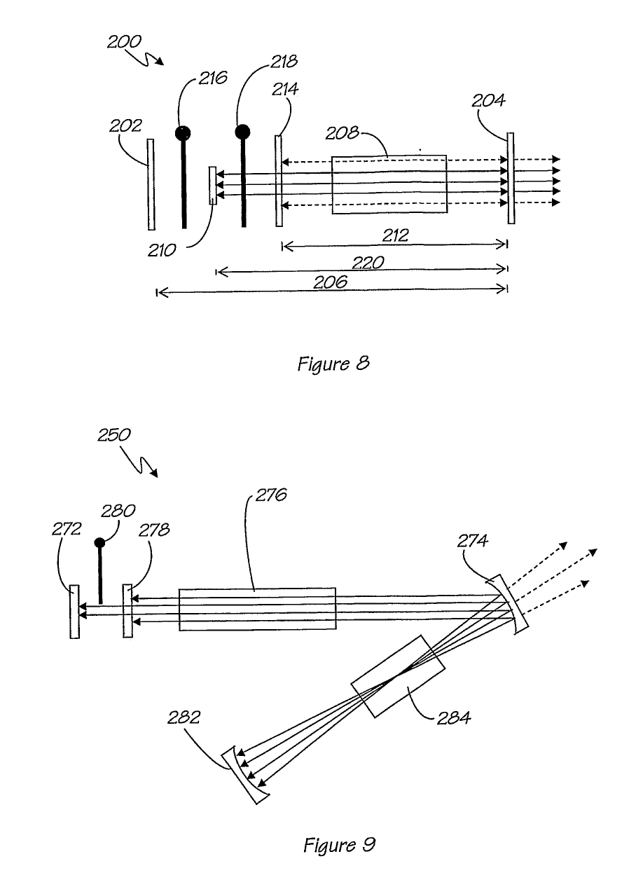

The concepts of the triple resonator, etalon/polarizer and the shutter may also be added to this system of FIG. 7. An example is shown in FIG. 8, in which the system may be switched from 1.06 μm, to dual 1.06/1.3 μm, to 1.3 μm using two shutters. Thus in FIG. 8, laser system 200 comprises first reflector 202 and second reflector 204, which define resonator cavity 206. Laser material 208 is disposed between reflectors 202 and 204, and is capable of generating at least two different wavelengths of laser light when pumped by pump radiation (in this example 1.06 and 1.3 microns, when laser material 208 is Nd:YAG). Reflector 202 is highly reflective at 1.06 microns. A third reflector 210 is disposed between the reflector 202 and laser material 208, and is not large enough to use the entire gain volume, so the gain volume is shared with the 1.3 μm transition. Reflector 210 is highly reflective at 1.06 microns. Reflectors 204 and 210 define resonator cavity 212. A fourth reflector 214 is disposed between reflector 210 and laser material 208, and is transmissive highly transmissive at 1.06 μm, but highly reflective at 1.3 μm. A first shutter 216 is disposed between reflectors 202 and 210 so as to prevent laser light generated by laser material 208 from passing to reflector 202 when shut, and to permit laser light generated by laser material 208 to pass to reflector 208 when open. A second shutter 218 is disposed between the reflectors 210 and 214 so as to prevent laser light generated by laser material 208 from passing to reflector 210 when shut, and to permit laser light generated by laser material 208 to pass to reflector 210 when open. Reflectors 214 and 204 define resonator cavity 212 and reflectors 210 and 204 define resonator cavity 220.

In operation, pump radiation (not shown) is directed to Nd:YAG laser material 208 and thereby causes laser material 58 to generate laser light at 1.06 and 1.3 microns. When shutters 216 and 218 are both open, laser light at 1.06 microns resonates within the system, both in cavity 220 and in cavity 206, as both reflectors 202 and 210 are reflective to 1.06 microns laser light and reflector 214 is transmissive to 1.06 microns. A laser beam at 1.06 microns can then be outputted through reflector 204, acting as an output coupler. When shutter 216 is closed and shutter 218 is open, both 1.3 microns and 1.06 micron laser wavelengths resonate and are spatially (laterally) separated: 1.3 microns in cavity 212 and 1.06 microns in cavity 220. This is analogous to the process occurring in the system described in FIG. 7. When shutters 216 and 218 are both closed, laser light at 1.06 microns can not resonate, since it is prevented by shutter 218 from reaching either reflector that is reflective to 1.06 microns light. Accordingly the energy of the 1.06 micron beam, will be transferred to the 1.3 microns beam, which is reflected by the reflector 214, and resonates within system 200 (i.e. within resonator 212) and may be outputted through reflector 204, acting as an output coupler. Thus reflector 210 is not large enough to use the entire gain volume, so the gain volume is shared with the 1.3 μm transition. 202 is large enough to fill the gain volume, so if both shutter are open, 1.06 μm will completely dominate all of the gain.

For simplified construction, a design may use two spatially separated coatings on the same mirror substrate. This could be done on either both sides or on a single side. To minimise diffraction effects, some of the mirrors may also have Gaussian reflectance profiles to avoid a hard diffraction edge.

### 1.06/1.3 μm Simultaneous Operation and Sum Frequency Mixing (SFG)

Sum frequency mixing of two wavelengths requires both transitions to work simultaneously in a high-Q cavity. The mixing also requires that the two beams (having the two wavelengths) are compressed or imaged into a non-linear crystal, where some degree of spatial overlap must occur.

An example resonator design is shown in FIG. 9. The system of FIG. 9 comprises a system similar to that shown in FIG. 5 (although a system similar to that of FIG. 6, having an iris or aperture instead of a shutter may be used) in which the system is folded and comprises a non-linear medium. Thus with reference to FIG. 9, laser system 250 comprises first reflector 272 and second reflector 276, together with reflector/output coupler 274. Laser material 276 (Nd:YAG) is disposed between reflectors 272 and 274, and is capable of generating laser light at 1.06 and 1.3 microns when pumped by pump radiation. Third reflector 278 is disposed between reflector 272 and laser material 276, and is transmissive towards laser light at 1.06 microns, which generated by the laser material with highest gain, and reflective towards laser light at 1.3 microns. Shutter 280 is disposed between reflector 272 and reflector 278 so as to prevent laser light generated by laser material 276 from passing to reflector 272 when shut, and to permit laser light generated by laser material 276 to pass to reflector 272 when open. Laser system 250 also comprises non-linear medium 284 disposed between reflectors 274 and 282. Non-linear medium 284 may be a sum frequency generator such as LBO. Reflector 274 provides the fold in folded system 250, and is highly reflective towards laser light at 1.3 and 1.06 microns, and transmissive towards laser light that has been converted by non-linear medium 284. The converting may be SFG, SHG or DFG. Reflector 274 is therefore capable of functioning as an output coupler for system 250. It is transparent to the desired output wavelength(s) and reflective towards system wavelengths that are not outputted. Reflectors 274 and 282 are curved, so that the two wavelengths of laser light (1.3 and 1.06 microns) at least partially overlap within nonlinear medium 284 if both are resonating in the system.

As described above for the system 10 in FIG. 5, when shutter 280 is in an intermediate position, both 1.3 and 1.06 micron wavelengths resonate within system 250 in portions of the system that are partially spatially separated. Both of these wavelengths are reflected by reflector 274 such that they overlap within nonlinear medium 284. Non-linear medium 284 then sums the frequencies to generate 589-593 nm laser light, which may be outputted through output coupler 274. It may be necessary to tune nonlinear medium 284 to give rise to SFG. The tuning may be by means of a tuner (either a temperature tuner or an angle tuner, not shown). When shutter 280 is shut, only the 1.3 micron beam can resonate in system 250, and nonlinear medium 284 can frequency double the laser beam to generate an output wavelength of 660-670 nm. It may be necessary to tune nonlinear medium 284 to give rise to SHG as described above for SFG. Similarly, when shutter 280 is open, only the 1.06 micron beam can resonate in system 260, consequent frequency doubling by nonlinear medium 284 results in an output wavelength of 532 nm. Thus operating shutter 280 can result in switching between three separate wavelengths of output laser light (532 nm, 589-593 nm and 660-670 nm) without realignment of optical components of the system. Since that the gain of the 1.06 μm transition is quite high, the reflectance of the reflector 278 at 1064 nm must be quite low (<2%).

The present arrangement allows the possibility to optimize the ratio of two different wavelengths of laser light (e.g. 1.06 μm and 1.3 μm) for maximum conversion to the sum frequency. It may be necessary to change the ratio when varying power levels, pulse rate or other operating parameters.

It may be important to consider that Nd:YAG is capable of generating two closely spaced wavelength at 1.3 μm (1.32 μm and 1.34 μm). For reliable operation at high pulse energies, it may be necessary to ensure that both wavelengths under go nonlinear conversion, or that the one wavelength is suppressed, in order to prevent the intracavity field at this second wavelength from building up to levels that damage the resonator. This may be achieved in practice by careful design of the mirror spectrum, inserting a intracavity filter or etalon, or by using two intracavity nonlinear media in order to convert both wavelengths by SFG with 1.06 μm.

Thus laser system 250 may be used to generate yellow, red or green radiation.

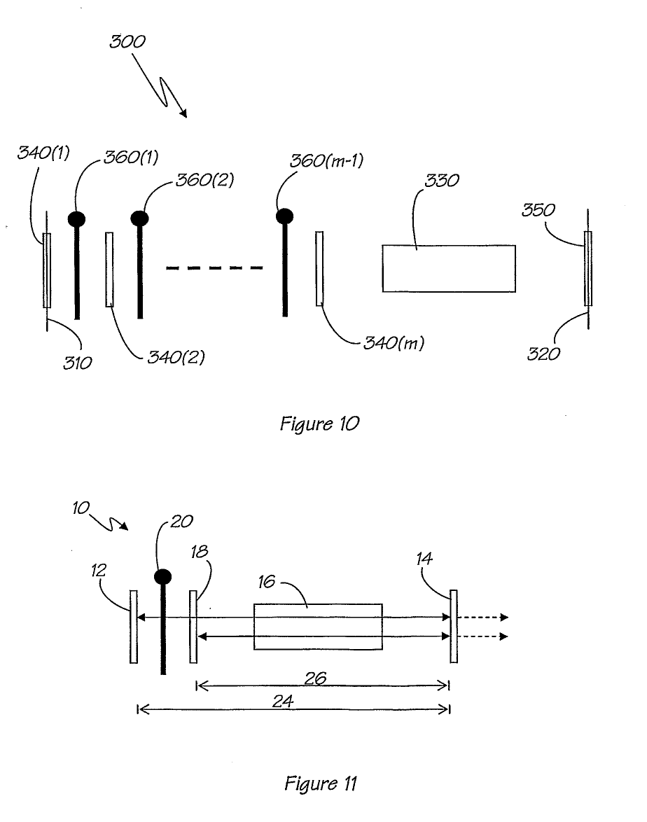

The arrangements of the laser system may be generalised to have any desired number of possible output wavelengths, provided that a laser material is available capable of generating the appropriate wavelengths, Thus FIG. 10 illustrates a laser system 300 capable of selectively outputting m different wavelengths of output laser beam, where m is an integer greater than 1. System 300 has first end 310 and second end 320. System 300 comprises laser material 330 which is capable of generating n different wavelengths of cavity laser beam, where n is an integer greater than or equal to m. First reflector 340(1) is located at the first end 310 of the system, and is reflective to the first wavelength of cavity laser beam. End reflector 350 is located at the second end 320 of the system and is at least partially reflective towards all wavelengths that resonate in system 300. Second to mth reflectors, 340(2) to 340(m) respectively (not all of which are shown for m>3), are also provided between first reflector 340(1) and laser material 330. For each p between 2 and m inclusive, the pth reflector 340(p) is reflective to the pth wavelength of cavity laser beam and has low reflectivity and high transmissivity towards the 1^{st} to (p−1)th wavelengths of cavity laser beam. In system 300, each of the reflectors 340(1) to 340(m) are located between the (p−1)th reflector 340(p−1) and laser material 330. System 300 also comprises shutters 360(1) to 360(m-1) (not all of which are shown for m>3), where for each p between 1 and m-1, shutter 360(p) is located between reflector 340(p) and reflector 340(p+1), and is capable, when shut, of preventing laser light from laser material 330 from reaching reflector 340(p) and, when open, of permitting laser light from laser material 330 to reach reflector 340(p). For each p, the pth wavelength is generated by laser material 330 at greater gain than the (p+1)th wavelength.

In operation, laser material 330 generates m wavelengths (optionally more than m), when pumped by pump radiation (not shown in FIG. 10). If each shutter 360(1) to 360(m) is open, the first wavelength, generated at highest gain, resonates between reflectors 340(1) and 350. The energy of other wavelengths generated by laser material 330 will be diverted into the first wavelength, since it is generated at highest gain. If all shutters except 360(1) are open and shutter 360(1) is shut, then laser light is prevented by shutter 360(1) from reaching reflector 340(1), and the first wavelength can not resonate (as it is not reflected by reflectors 340(2) to 340(m)). This enables the second wavelength to resonate between reflectors 340(2) and 350. Similarly, other wavelengths will be disfavoured as they are produced at lower gain, and their energy will be diverted into the second wavelength. Similarly, in order to enable the pth wavelength to resonate, the p-1th shutter 360(p−1) should be shut and the pth to (m-1) to 360(m-1) should be open. In this way, the first to (p−1)th wavelengths will be prevented from resonating by shutter 360(p−1) and because they are not reflected by reflectors 360(p) to 360(m), and their energy will be diverted into the pth wavelength, which resonates between reflectors 340(p) and 350. Thus the wavelength that resonates in system 300 may be rapidly and efficiently selected by operation of the appropriate shutter or shutters, without realignment of any optical components of the system. The selected wavelength may be outputted through reflector 350 acting as an output coupler, or may be outputted using a separate output coupler (not shown) located either between reflector 340(m) and laser material 340 or between laser material 340 and reflector 350.

In the case where the arrangement of the laser system requires operation of two (or more) transitions simultaneously, the two wavelengths are operated using spatial separation, which avoids the complicated dynamics of gain-balanced systems.

The arrangements of the laser systems disclosed herein solve several problems:

Various clinical treatments require different wavelengths. Current technology relies on setting up each laser to produce a single output wavelength and consequently the clinician must purchase multiple systems. There is very little technology capable of making a laser system switchable between multiple wavelengths, and most currently available commercial systems producing multiple wavelengths contain multiple lasers. The present invention allows convenient switching between several key clinical wavelengths in a single system, using a single laser head, which reduces cost and complexity of providing multiple wavelengths.

The present invention also allows production of several important clinical wavelengths simultaneously, which provides the possibility of new treatments.

Using simultaneous operation and sum frequency mixing, yellow radiation (which is extremely important and difficult to produce at high energy) can also be produced. Yellow generation from a simple solid state system such as is provided by an arrangement of the laser systems herein disclosed has many advantages over current yellow laser technology. Along with these advantages, the system can also produce IR and visible radiation simultaneously, which provides the possibility of new treatments.

Lasers for use in medical treatments are expensive. The provision of multiple lasers to provide multiple wavelengths may become prohibitively expensive. Thus it is a benefit to provide a single system capable of switchably providing multiple wavelengths.

A further aspect of the laser system includes a method of using laser light for treating, detecting or diagnosing a selected area requiring such diagnosis or treatment on or in a subject comprising illuminating the selected area with the output laser beam from an arrangement of the laser system. The selected area may be illuminated with a laser beam having a wavelength for a time and at a power level which is appropriate and effective for the diagnosis or therapeutically effective for the treatment. The subject may be a mammal or vertebrate or other animal or insect, or fish. The subject may be a mammal or vertebrate which is a bovine, human, ovine, equine, caprine, leporine, feline or canine vertebrate. Advantageously the vertebrate is a bovine, human, ovine, equine, caprine, leporine, domestic fowl, feline or canine vertebrate. The method finds particular application in treating the eyes and skin of a mammal or vertebrate.

The laser system may also be used in connection with holograms, in diagnostic applications (for example in displays, fluorescence detection, cell separation, cell counting, imaging applications), military systems (e.g. for military countermeasures, underwater systems, communication, illumination, ranging, depth sounding, mapping contours such as a sea floor), ophthalmology, urology, surgery (e.g. vascular surgery) for purposes including cutting, coagulation, vaporization, destruction of tissue etc., stimulation, photodynamic therapy etc., gas detection, treatment of skin disorders e.g. psoriasis. It may be used in dermatological applications such as treatment of spider veins, or treatment of acne, skin rejuvenation or treatment of hypopigmentation due to sun damage. The laser system may be used in combination with other therapies, for example treatment with drugs, creams, lotions, ointments etc. (e.g. steroids), optically clearing agents, other device based therapies etc.

A further aspect includes a method for displaying laser light on a selected area comprising illuminating the selected area with the output laser beam from an arrangement of the laser system. The laser system arrangement may also comprise use of an aim beam in order to aim the output laser beam towards the selected area. The aim beam may have a wavelength in the visible range. Accordingly, the laser system may also comprise a source of the aim beam, which may be a diode laser, an LED or some other suitable source. A mirror, which may be a dichroic mirror, may also be provided in order to direct the aim beam in the same direction as the output laser beam.

It is well-known that visible light, in particular green/yellow and red light can be used to target a variety of chromophores present in human or animal tissue. These chromophores include melanin, haemoglobin, collagen-related constituents and also porphyrin, which is present for example at bacteria sites associated with acne.

As a consequence, green, yellow and red light can be used to treat a wide variety of medical conditions and to perform a variety of cosmetic procedures. Many of these treatments involve eye and skin, and examples include retinal procedures, treatment of vascular and pigmented lesions, collagen rejuvenation, wound and scar healing and acne treatment.

In addition to the natural chromophores listed above, special dyes may be incorporated into body tissues, which react with certain components of body tissue when activated by particular wavelengths of light. This process is called photodynamic therapy, and is being used increasingly to treat a range of medical disorders ranging from cancer to skin and eye disorders.

In using a laser to provide any of the treatments above, there is an optimum wavelength of the laser light which provides the best clinical effectiveness with fewest side effects. This optimum wavelength depends on the condition being treated, the chromophore being targeted and the characteristics of the surrounding tissues (e.g. skin type).

The laser systems described in this specification offer a particular advantage to clinicians, in that several wavelengths can be output from a single solid-state laser device. The ability to switch between wavelengths is an important benefit to clinicians (for example doctors, dermatologists, ophthalmologists, cosmetic physicians) because it enables them to treat patients with a wider range of skin types and a wider range of medical or cosmetic complaints. The laser described herein has the ability to be made compact and portable. Additionally switching may be accomplished without realignment of optical components (reflectors, laser medium etc.).

To achieve a similar range of wavelengths using conventional laser sources, a clinician would need to use multiple laser sources, which is a costly and space-consuming option.

The table below summarises the applications to which arrangements of the present laser system may be applied, together with the wavelengths suitable for those applications.

| | Laser output wavelength | | | | | | |
|---|---|---|---|---|---|---|---|
| | UV (nom. | Green (nom. | Yellow (nom. | Red (nom. | IR (nom. | IR (nom. | IR (nom. |
| Conditions treated | 310-311 nm) | 532 nm | 579 or 588) | 621, 635 or 660 nm) | 1064 nm | 1156/1177 Nm) | 1319/1320 nm) |
| Tattoo removal | | ✓ | ✓ | ✓ | ✓ | | ✓(?) |
| Hair removal | | | | | ✓ | | ✓ |
| Skin rejuvenation/ | | ✓ | ✓ | ✓(?) | ✓ | | ✓ |
| tightening | | | | | | | |
| Vascular | | ✓ | ✓ | ✓(?) | ✓ | | ✓ |
| lesions/rosacea/ | | | | | | | |
| Port wine stains | | | | | | | |
| Leg vein | | ✓ | ✓ | ✓(?) | ✓ | | ✓ |
| (varicose) removal | | | | | | | |
| Pigmented lesions | | ✓ | ✓ | ✓(?) | ✓ | | ✓(?) |
| Scars/keloids | | | ✓ | ✓(?) | ✓(?) | | ✓ |
| Cellulite removal | ✓ | ✓ | ✓ | ✓ | ✓ | ✓(?) | ✓(?) |
| Psoriasis/Vitilago | ✓ | | ✓ | | | | |
| Autoimmune | | | | | | | |
| disease/eczema | | | | | | | |
| Acne | | ✓ | ✓ | ✓ | ✓ | | ✓ |
| Actinic | | | | | ✓(?) | | ✓ |
| Keratoses/Skin | | | | | | | |
| cancer | | | | | | | |
| Photodynamic | ✓ | ✓ | ✓ | ✓ | x(?) | | x(?) |
| therapy | | | | | | | |
| Other medical | ✓ | ✓ | ✓ | ✓ | ✓ | | ✓(?) |
| procedures, e.g. | | | | | | | |
| benign prostate | | | | | | | |
| hyperplasia, atrial | | | | | | | |
| fibrillation, | | | | | | | |
| ophthalmology, | | | | | | | |
| clot removal, | | | | | | | |
| removal | | | | | | | |
| (vaporization) of | | | | | | | |
| tissue | | | | | | | |

The symbol ✓(?) in the above table indicates that the indication is likely but not certain. For tattoo removal applications it is preferable that the laser system be Q switched. Likewise a number of pigmented lesion applications may require a Q switched laser.

Arrangements of the laser system and/or methods disclosed herein are able to treat any of the above conditions by using a single wavelength or multiple wavelengths in the order and spaced by time that is matched to a patient's clinical status. Alternatively, multiple wavelengths may be applied to a patient concurrently e.g. as the IR and visible lasers may come from separate rods it is possible to apply IR and visible together or spaced by a time factor selected by the clinician from a range offered by the apparatus.

In some arrangements of the laser system, by appropriate design of the output coupler, the laser with intracavity frequency conversion may also be configured to switch the laser output between a first fundamental wavelength and the second harmonic of the second fundamental wavelength. For the example of Nd:YAG, the laser can made switchable between 1.06 μm and 650 nm, or between 1.32 μm and 532 nm. In this manner the switchable laser system (having fundamental wavelengths of 1.06 μm 1.32 μm) may be configured to alternately deliver firstly a desired amount of output radiation at the first wavelength (being the first fundamental wavelength in the infrared eg. 1.06 μm or 1.32 μm) and secondly a desired amount of output radiation at the frequency converted/doubled wavelength of the second fundamental wavelength (eg. either 660 nm or 523 nm respectively).

The output coupling at the first fundamental wavelength is preferably in the range similar to that optimal for a standard 2-mirror laser operating at that wavelength. For example, in an arrangement similar to that given in Example 2 below, and with the first fundamental wavelength chosen to be 1.06 μm, the optimum output coupling at the first fundamental wavelength is approximately 50%. The output coupler preferably has high reflectivity (i.e greater than 98%) at the second fundamental wavelength and high transnmssion at the second harmonic of the second fundamental wavelength. When selecting output at the second harmonic of the second fundamental wavelength, the shutter is positioned to select the second fundamental wavelength according to the current invention as described above, and the nonlinear medium is tuned to convert the output to the second harmonic. When selecting output at the first fundamental wavelength, the shutter is positioned to generate the first fundamental wavelength. In this case the nonlinear medium element is tuned away from phase-matching at the first fundamental wavelength so to not generate any output at the second-harmonic of the first fundamental wavelength, and is effectively a passive element.

In an additional arrangement for switchably outputting either a first fundamental wavelength and a frequency converted wavelength of a second fundamental beam, it can be realised that the non linear material does not need to be tuned away from frequency converting the second fundamental wavelength since it does not frequency convert the first wavelength and, when the laser system is switched to output the first fundamental wavelength, the nonlinear material is adapted to convert a wavelength that isn't allowed to resonate. The laser system may be adapted such that the first fundamental wavelength has more gain then the second and will extract all the energy before any of the second fundamental wavelength can be amplified and frequency doubled.

For the example of 1.06 μm/660 nm switching, one of the end mirrors must be an appropriate output coupler for 1.06 μm, such that 1.06 μm output will still dominate the high-Q 1.3 um cavity (note this output coupling may not be totally optimal, as it must also allow sufficient gain at 1.06 μm to dominate the 1.3 μm). The 1.06 μm output coupler could be the end mirror that is visible when the shutter opens, or it could be the other end mirror such that the open shutter reveals a reflector that is highly reflective at 1064. The 1.32 μm cavity must be high-Q for 1.32 μm to optimise the frequency conversion process. The switching between from 1.06 μm to 660 nm would occur as the shutter is closed, which would drop the cavity Q for 1.06 μm and allow the high-Q 1.32 μm cavity to dominate completely and be output coupled through the tuning mirror as the frequency converted output (660 nm).

For the example of 1320/532 nm switching, to output 1.32 μm, the output coupler can only be the end mirror NOT near the shutter, as the end mirror near the shutter would cause the 1.32 μm output to go straight into the closed shutter. With the shutter closed, there is significant loss at 1.06 μm, such that 1.32 μm is outputted from the cavity. To output 532 nm, the shutter would open and cause the 1.06 μm cavity to go high-Q, which would then dominate the 1.32 μm transition completely and be subsequently frequency converted to 532 nm, which is then output coupled through the turning mirror.

In further arrangements still, it is possible to vary the ratio of the output between that of the first fundamental wavelength and the frequency converted second fundamental wavelength using a continually adjustable shutter and spatial separation of the respective resonator cavities as previously described.

### Examples

### Example 1-1.06 and 1.3 μm Switching

FIG. 11 shows a diagrammatic representation of the laser used in Example 1 which is configured in the arrangement of FIG. 1. Reflector 12 is highly reflective (HR) at a wavelength of 1064 nm; reflector 18 has a reflectivity of less than 1% at 1064 nm and greater than 99.9% at a wavelength of 1340 nm; and reflector 14 had a reflectivity of approximately 70% at 1319 nm and approximately 35% at 1064 nm.

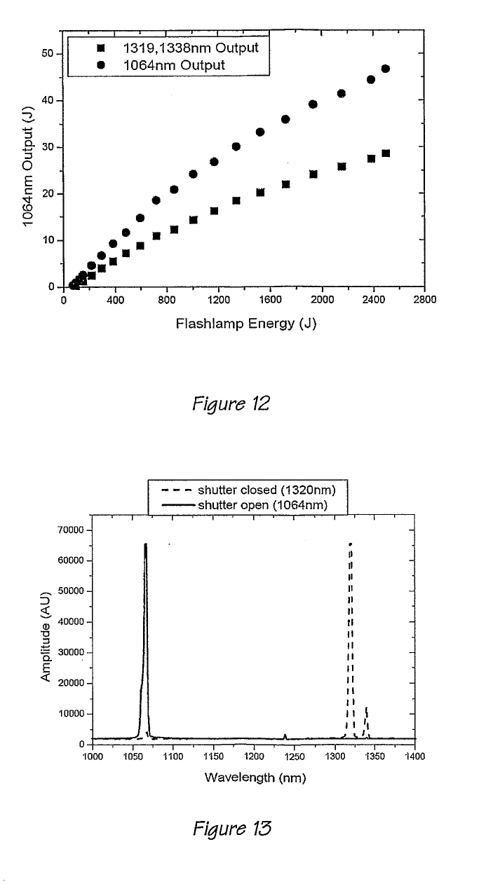

FIG. 12 shows the output energy at each wavelength (shutter either closed or open), and FIG. 13 shows the outputs with the shutter either open or closed. This has been verified with energies up to about 50 J at 1064 nm and about 30 J at 1319, 1338 nm combined (FIG. 12). As can be seen from FIG. 13, both wavelengths operated almost completely pure through the full operational output. A small amount of 1064 nm was detected when operating at 1.3 μm at full energy, but this was very minor and was most probably due to amplified spontaneous emission (ASE).

### Example 2

### Sum Frequency Mixing to Produce Yellow at 589 nm

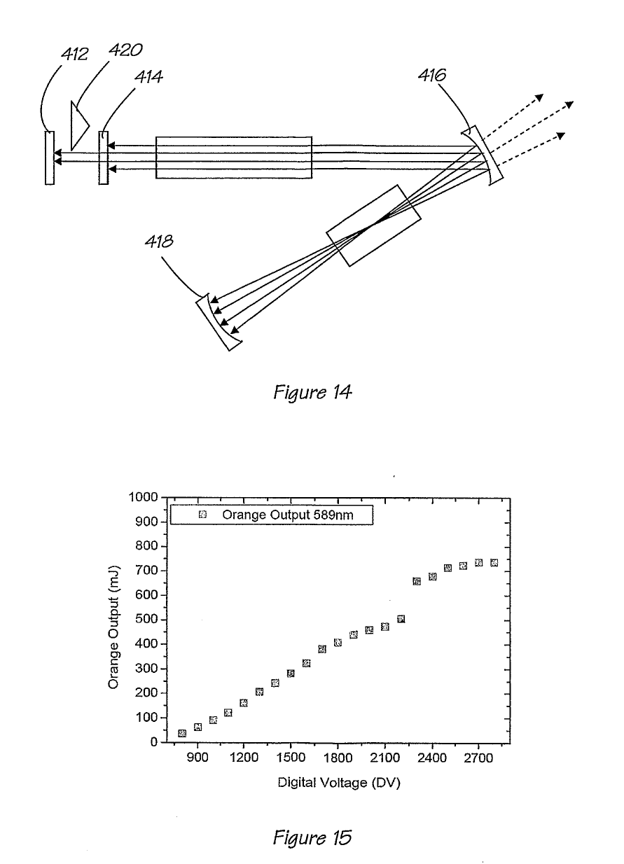

FIG. 14 shows a diagrammatic representation of the laser used in Example 2. Reflector 412 was highly reflective (HR) at a wavelength of 1064 nm; reflector 414 had a reflectivity of less than 1% at 1064 nm and greater then 99.9% at a wavelength of 1340 nm; and reflector 416 was a 50 cm concave HR at wavelengths of 1064, 1319 and 1338 nm. Reflector 416 also had a transmissivity of approximately 80% at 589 nm. Reflector 418 was a 20 cm concave HR at 1064, 1319 and 1338 nm and also had a transmissivity of approximately 80% at 589 nm.

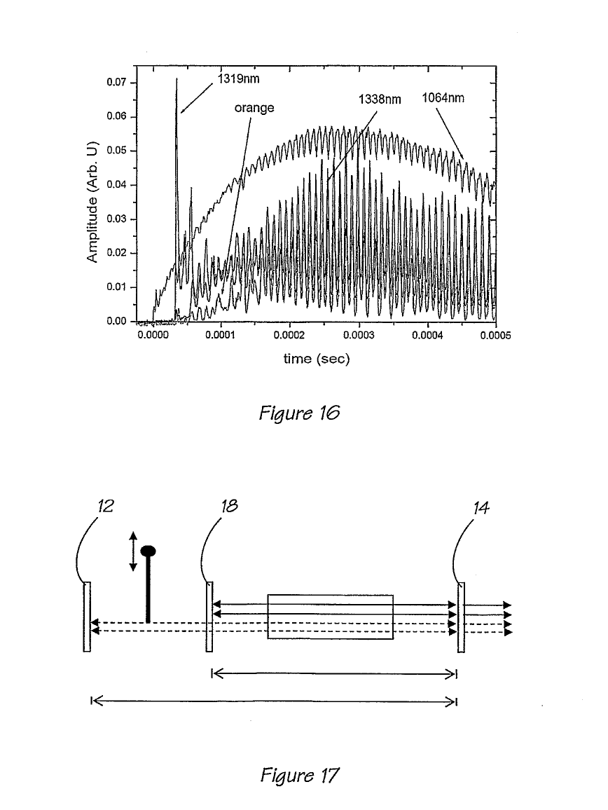

The setup of FIG. 14 used a prism 420 (refractive element) as the translatable shutter to obtain operation at both the 1.06 and 1.3 μm transitions. This resonator produced 0.7 J of yellow output in a 10 msec pulse train (combined output from reflector 416 and reflector 418, to obtain a single output, Reflector 418 should be a high reflector at 589 nm as well as the infrared). An output characteristic as well as a temporal trace of a sub pulse are shown in FIGS. 15 and 16 respectively. Temporally, the 1.3 μm lines operated in phase with each other and closely to the sum frequency output, while the 1.06 μm operated out of phase with everything else. This occurs because the 1.06 μm field builds much faster than the 1.3 μm field, due to the round trip gain differential. In this situation, a spike of 1.3 μm output partially depletes the 1.06 μm field (and completely depletes itself) as it is efficiently output coupled as sum frequency output.

### Example 3

### Dual IR Operation of 1.06 and 1.3 μm Output

FIG. 17 shows a diagrammatic representation of the laser used in Example 3 with a translatable shutter 50. Details of the reflectors 12, 18 and 14 and spacings are the same as for Example 1.

Operation of this resonator was verified in the multi joule range, although output was not recorded as this is basically the same cavity as described for FIG. 1 for switchable output, except the shutter was only partially closed. The output was the same as in Example 1, except that the combined output slope lay between the pure 1.06 and 1.3 μm slopes, reflecting the efficiency difference between the two. The 1.06 μm and 1.3 μm output as a fraction of the total output pulse energy was similar to that depicted in the FIG. 5A.

In an aspect of the present laser system, the laser is capable of having two different wavelengths of laser light resonating simultaneously in spatially separate, optionally laterally separate, portions of the system. FIG. 18 illustrates pairs of reflectors that are capable of achieving this. These may optionally comprise coatings on one or both sides of a mirror. In FIG. 18A to 18E, reflector 3 is generally transmissive towards a first wavelength of laser light generated by the laser material (the highest gain wavelength) and transmissive towards a second wavelength (generated at lower gain than the first wavelength). Reflector 1 is reflective towards the second wavelength. Laser light from the laser material impacts on the reflectors as shown by arrows 2. (Reflector 1 and reflector 3 correspond in certain cases to the first and third reflectors referred to above). It will be understood that the descriptions below refer to systems into which these reflectors are incorporated, and include an end reflector which can act as an output coupler, is a laser material and a pump source for pumping the laser material to produce at least the first and second wavelengths.

In FIG. 18A, reflector 1 is smaller than reflector 3 and located behind reflector 3 relative to the laser material. Thus the first wavelength passes through reflector 3 and is reflected by reflector 1 and can therefore resonate in the system. However laser light of the first wavelength can not resonate where it does not reach reflector 1 as it is not reflected by either reflector. In these portions of the system, the second wavelength is reflected by reflector 3 and can resonate in the system. Thus the first wavelength will resonate in a central portion of the system and the third wavelength will resonate in an annular portion of the system surrounding the central portion.

In FIG. 18B, reflector 1 is coplanar with and surrounded by reflector 3. Thus the first wavelength is reflected by reflector 1 and can therefore resonate in a central portion of the system. However laser light of the first wavelength can not resonate where it does not reach reflector 1 as it is not reflected by either reflector. In these portions of the system, the second wavelength is reflected by reflector 3 and can resonate in the system. Thus the first wavelength will resonate in a central portion of the system and the third wavelength will resonate in an annular portion of the system surrounding the central portion.

In FIG. 18C, reflector 1 is smaller than reflector 3 and located in front of reflector 3 relative to the laser material. Thus the first wavelength is reflected by reflector 1 and can therefore resonate in the system. However laser light of the first wavelength can not resonate where it does not reach reflector 1 as it is not reflected by either reflector. In these portions of the system, the second wavelength is reflected by reflector 3 and can resonate in the system. Thus the first wavelength will resonate in a central portion of the system and the third wavelength will resonate in an annular portion of the system surrounding the central portion.

In FIG. 18D, reflector 1 is coplanar with reflector 3. Thus the first wavelength is reflected by reflector 1 and can therefore resonate in a first portion of the system. However laser light of the first wavelength can not resonate where it does not reach reflector 1 as it is not reflected by either reflector. In these regions, the second wavelength is reflected by reflector 3 and can resonate in the system. Thus the first wavelength will resonate in the first portion of the system and the third wavelength will resonate in a second portion of the system laterally separated from the first portion. In FIG. 18D, the portion of the system in which the first wavelength can resonate is towards the top, and the portion of the system in which the third wavelength can resonate is towards the bottom.

In FIG. 18F, reflector 1 is located behind reflector 3 relative to the laser material. Shutter 4, shown here as partially shut, prevents laser light from reaching an upper portion of reflector 1. Thus in the upper portion, only the second wavelength can resonate, since it is reflected by reflector 3. However the first wavelength can reach the lower portion of reflector 1, and therefore can resonate in the lower portion of the system.

It will be understood that other configurations similar to those shown in FIG. 18 may achieve the same effect using the same principles.

It will be appreciated that the laser systems, apparatus, and methods of operating a laser system described in the above description and examples and/or illustrated in the figures above at least substantially provide a for generating visible output with high energy and a method for operating the laser at such high energy and high average power without causing damage to components of the laser.

The laser systems, apparatus, and methods of operating a laser system described herein, and/or shown in the drawings, are presented by way of example only and are not limiting as to the scope of the invention. Unless otherwise specifically stated, individual aspects and components of the laser systems and/or methods may be modified, or may have been substituted therefore known equivalents, or as yet unknown substitutes such as may be developed in the future or such as may be found to be acceptable substitutes in the future. The laser systems and/or methods may also be modified for a variety of applications while remaining within the scope and spirit of the claimed invention, since the range of potential applications is great, and since it is intended that the present laser systems and/or methods be adaptable to many such variations.

1.-66. (canceled)

67. A laser system comprising:
a first reflector and a second reflector defining a first resonator cavity;
a third reflector defining a second resonator cavity with the second reflector;
a laser material disposed such that it is located in both the first and the second resonator cavities, the laser material being capable of generating at least a first and a second wavelength of laser light when pumped by pump radiation from a pump source located external to the first and second resonator cavities;
wherein the first reflector is adapted to reflect the first wavelength of laser light into the first resonator cavity and the third reflector is adapted to reflect the second wavelength of laser light into the second resonator cavity.

68. A laser system as claimed in claim 67, wherein the first and second resonator cavities have different spatial modes, each spatial mode corresponding to a different gain volume of the laser material, wherein the first wavelength of laser light resonates in the first resonator cavity and the second wavelength of laser light resonates in the second resonator cavity.

69. A laser system as claimed in claim 67, wherein the first reflector and the third reflector are co-located.

70. A laser system as claimed in claim 67, further comprising a selection means continuously movable between a first and a second position, wherein when the selection means is in the first position, the second wavelength of laser light resonates in the second resonator cavity, and when the selection means is in the second position, the first wavelength of laser light resonates in the first resonator cavity.

71. A laser system as claimed in claim 67, wherein the first resonator cavity is spatially separated from the second resonator cavity such that the first and second wavelengths of laser light are able to resonate in spatially separated regions of the laser material.

72. A laser system as claimed in claim 70, wherein when the continuously movable selection means is intermediate the first and second positions, the first wavelength resonates in the first resonator cavity and the second wavelength resonates in the second resonator cavity and wherein the ratio of the optical power generated at the first and second wavelengths is variable as the selection means is moved between the first and second positions.

73. A laser system as claimed in claim 70, wherein the selection means located in either the first or the second resonator cavity and is either a refractive selection means or a diffuse scatterer selection means selected from the group of an electro-optic or an acousto-optic modulator

74. A laser system as claimed in claim 70, wherein the selection means further comprises a variable aperture with radius continuously adjustable between a first and second radius position, wherein when the variable aperture is in the first radius position, the laser light generated by the laser material is allowed to impinge on the central region and prevented from impinging on the annular region of the reflective surface of the first reflector selection means, and in the second radius position, the laser light generated by the laser material is allowed to impinge on both the central region and the annular region of the reflective surface of the first reflector selection means.

75. A laser system as claimed in claim 67, wherein the laser comprises a mode-locked laser comprising a Q-switch located in the first resonator cavity and the second cavity for generation of pulsed laser light at both the first and the second wavelengths of laser light.

76. A laser system as claimed in claim 67, further comprising:
a nonlinear material located in the first and the second resonator cavities, wherein the nonlinear material is phase-matched for frequency conversion of either or both of the first and the second wavelength of laser light by either second harmonic generation, sum frequency generation or difference frequency generation to generate laser light at a frequency converted wavelength; and
an output coupler adapted for outputting at least a portion of either the first or the second wavelengths of laser light and at least a portion of the frequency converted wavelength of laser light.

77. A laser system as claimed in claim 76, wherein the nonlinear material is tunable to selectively frequency convert at least one of the first and second wavelengths of laser light to generate a frequency converted wavelength selected from the group of the second harmonic wavelength of the first wavelength, the second harmonic wavelength of the second wavelength, the sum-frequency wavelength of the first and the second wavelengths, or the difference-frequency wavelength of the first and the second wavelengths, and wherein the laser further comprising a tuner for tuning the non-linear medium.

78. A laser system as claimed in claim 77, wherein the nonlinear material is either temperature tuned or angle tuned.

79. A laser system as claimed in claim 76, wherein the laser system further comprises at least one additional reflector located in the first and the second resonator cavities intermediate the laser material and the nonlinear material to define a folded resonator cavity.

80. A laser system as claimed in claim 67, wherein the laser further comprises an etalon located in either the first or the second resonator cavity.

81. A laser system as claimed in claim 67, wherein the cross-sectional radial extent of either the first or the third reflector is less than the cross-sectional radial extent of the laser material.

82. A laser system as claimed in claim 67, comprising a plurality of additional reflectors defining a corresponding plurality of additional resonators, each additional resonator adapted to resonate a corresponding plurality of additional wavelengths of laser light.

83. A laser system as claimed in claim 70, further comprising
a plurality of additional reflectors defining a corresponding plurality of additional resonators, each additional resonator adapted to resonate a corresponding plurality of additional wavelengths of laser light; and
a plurality of selection means each movable between a first and a second position;
wherein the second reflector is adapted to output the first, second and the additional wavelengths of laser light, and the wavelength of laser light that is output is selectable by the relative positions of each of the selection means.

84. A laser system comprising:
a first reflector and a second reflector defining a first resonator cavity;
a third reflector defining a second resonator cavity with the second reflector;
a laser material disposed such that it is located in both the first and the second resonator cavities, the laser material being capable of generating at least a first and a second wavelength of laser light when pumped by pump radiation from a pump source located external to the first and second resonator cavities;
wherein the first and second resonator cavities have different spatial modes, each spatial mode corresponding to a different gain volume of the laser material, wherein the first wavelength of laser light resonates in the first resonator cavity and the second wavelength of laser light resonates in the second resonator cavity.

85. A method for generating a desired wavelength of laser light, comprising:
a) providing a laser system as claimed in claim 70;
b) pumping the laser material of the laser system so as to generate laser light at a first and a second wavelength;
c) moving the selection means so as to select either the first or the second wavelength of laser light; and
d) outputting the selected wavelength of laser light from the laser.

86. A method as claimed in claim 85, wherein step (d) comprises frequency converting the selected wavelength of laser light in a nonlinear material to generate frequency converted laser light and outputting the frequency converted laser light from the laser.

87. A method as claimed in claim 85, wherein, when the laser comprises a non-linear medium for frequency converting one or more wavelengths of laser light resonating in the system, the method further comprises:
tuning the non-linear medium to selectively frequency convert at least one of the first or second wavelengths of laser light by either second harmonic generation (SHG), sum frequency generation (SFG) or difference frequency generation (DFG); and
using the non-linear medium to convert at least one of the first or second wavelengths of laser light into a laser light at a frequency converted wavelength one for output from the laser.

88. A method as claimed in claim 85, wherein step (c) of the method comprises selecting a first wavelength of laser light using the selection means and frequency converting the first wavelength in a nonlinear material to generate frequency converted output laser light; and step (d) comprises illuminating a selected area with a desired number of pulses of the frequency converted output laser light.

89. A method for laser treatment, detection or diagnosis, comprising:
a) providing a laser system as claimed in claim 83;
b) pumping the laser material so as to generate at least two different wavelengths of laser light;
c) moving the selection means so as to select the ratio of intensities of the two wavelengths; and
d) outputting the laser beam having the selected ratio of intensities of the two wavelengths from the laser.
e) repeating steps (a) to (d) as required for the treatment, detection or diagnosis.

90. A method as claimed in claim 89, wherein step (c) of the method comprises selecting a first wavelength of laser light using the selection means and frequency converting the first wavelength in a nonlinear material to generate frequency converted output laser light; and step (d) comprises illuminating a selected area with a desired number of pulses of the frequency converted output laser light.

91. A method for generating a desired wavelength of laser light, comprising:
a) providing a laser system as claimed in claim 67;
b) pumping the laser material of the laser system so as to generate laser light at a first and a second wavelength;
c) selecting either the first or the second wavelength of laser light; and
d) outputting the selected wavelength of laser light from the laser.
